(19) United States
(12) Patent Application Publication
(10) Pub. No.: US 2014/0181793 A1
(43) Pub. Date: Jun. 26, 2014

(54) METHOD OF AUTOMATICALLY TESTING DIFFERENT SOFTWARE APPLICATIONS FOR DEFECTS

(71) Applicant: Karthikeyan Kaliappan, Middlesex (GB)

(72) Inventor: Karthikeyan Kaliappan, Middlesex (GB)

(73) Assignee: NET MAGNUS LTD., Middlesex (GB)

(21) Appl. No.: 13/884,627

(22) PCT Filed: Nov. 10, 2011
(86) PCT No.: PCT/GB2011/052189

§ 371 Date: Dec. 2, 2013

(30) Foreign Application Priority Data
Nov. 10, 2010 (GB) 1018991.8

(51) Int. Cl. G06F 11/36

(52) U.S. Cl. CPC G06F 11/3672; G06F 11/3684; G06F 11/368
USPC 717/124

(57) ABSTRACT

A method of automatically testing different software applications for defects, comprising the step of a test automation enabler (a) converting recorded test scripts into a generic format that is not application-centric and (b) storing the resultant non-application centric data in generic data containers. A computer-based implementation called OPUS can be easily operated by any user with basic knowledge of software testing principles and FTAT. After minimal training the user can use OPUS to implement test automation. OPUS is process based, methodical, stable, measurable, and repeatable by following a multi-stage process which is not domain, platform or application centric. The manual process of recording the test scripts is done in a functional test automation tool (FTAT). OPUS takes the recorded scripts, converts them into non application centric data and uses them for the automated testing process.

### BACKGROUND OF THE INVENTION

1. Field of the Invention

This invention relates to a method of automatically testing different software applications for defects, using a test automation enabler.

2. Description of the Prior Art

### What is Test Automation?

### Functional Testing—Manual

Functional testing is the process of manually testing software for defects. The process involves comparison of expected behavior of the application with the actual and generation of test reports and evidences. This is a very tedious and laborious process which is error prone.

Usually the manual test projects consume a large amount of effort and time and require a sizeable number of human resources to execute it.

### Refer FIG. 1. Process Diagram—Functional Testing (Manual)

### Functional Testing—Automation

Functional test automation on the other hand enhances the quality of testing by eliminating manual testing issues substantially. Functional test automation is the process of applying FTATs to test software applications. FTAT can automate most of the manual test processes and most times can add significant value. FTATs allow the users to define procedures to compare expected application behavior with the actual and determine the outcome

The following is the value proposition in using the FTAT.

1. Precision testing and accurate results

2. Less manual effort and shorter project timeline.

3. Smaller project teams as compared with manual testing projects

4. Automatic generation of reports and evidences.

5. Reliability on the reproducibility of test results

6. Reusability of processes and test automation assets

7. More scalable

### Refer FIG. 2: Process Diagram—Functional Automated Testing

### SUMMARY OF THE INVENTION

The invention is a method of automatically testing different software applications for defects, comprising the step of a test automation enabler (a) converting recorded test scripts into a generic format that is not application-centric and (b) storing the resultant non-application centric data in generic data containers.

The software applications can be of different types and/or run on different platforms and/or different domains. The test automation enabler configures the generic data for test execution and runs the test configuration using a chosen FTAT (functional test automation tool).

The invention is implemented in a computer-based system called OPUS.

### What is OPUS?

OPUS is a test automation enabler. It acts as an enabler to implement functional test automation using an FTAT.

OPUS is process based, methodical, stable, measurable, and repeatable by following a multi-stage process which is not domain, platform or application centric. The manual process of recording the test scripts is done in a FTAT. OPUS converts the recorded scripts into non-application centric data (e.g. is not specific to any single application under test) and performs the automated testing. Four types of databases are supported; Oracle, MySQL, IBM DB2, and SQL.

### Refer FIG. 11: Overview of OPUS.

Functional test automation can be implemented without the use of Opus. Refer FIG. 2.

The following are business benefits of using Opus in functional test automation:
1. It eliminates programming. The tool has does not need any programming and it is not an extension of any industry standard test automation framework.
2. It greatly reduces or eliminates design and development effort. Refer FIG. 9.
3. Opus is compatible and works with proprietary, free-ware and open-source tools, offering the business stakeholder a uniform and process driven functional test automation solution, irrespective of the FTAT or the QMS. Refer FIG. 7.
4. During Test Asset Generation, Opus identifies the unique business process from test cases by reverse engineering using a distinct method. Not only does it identify the unique functional paths or business processes but it also automatically groups associated test cases to those business processes. This enables the business user to test the AUT based on business processes rather than test cases
   Refer FIG. 10.
5. Opus has the capability to schedule and execute tests based on one or many combinations of business processes or test cases (using multiple configurations within Opus) across a network of systems without the aid of an QMS.

### Quick Overview

Using OPUS removes the need for technical expertise—In a fairly simple process OPUS picks up recorded test scripts, executes the selected tests, and uploads the results into a compatible Quality Management System. See Appendix H.
OPUS allows data to be modified by simple text editing on the User Interface—The values recorded for input fields, objects, or class names can easily be changed. Refer FIGS. 75, 76 and 77. See also Appendix H.
Redundant steps in test cases can be avoided using the Dynamic Key feature—specifics as in Unique Features of Opus below.
OPUS handles multiple test configurations and allows test cases to be grouped and configured based on user preferences.
OPUS identifies the unique business processes—Test cases are categorised based on their business flow and each process is given an identifier and multiple validation points. This empowers the user with a greater understanding of the processes and flows involved, making OPUS highly business centric.
OPUS Audit Trail allows changes to test data to be tracked—change history can be viewed and the data reverted to a specific change if necessary.
OPUS Version Differentiator—A revolutionary feature that analyses new versions of applications under test through an ingenious process, and locates changes in the version's user interface. The reports generated help gauge the impact of these changes, and greatly enhance the decision making process on the managing of the existing regression suites, and testing of the new version. OPUS successfully bridges the gap where traditional test automation fails.

### Unique Features of OPUS

1. Non-Application Centric Data (NCD)
OPUS is a test automation enabler in which different types of applications across platforms and domains can be automated. See Appendix A for a list of the platforms currently supported.
OPUS converts the recorded test scripts produced using the FTAT into an OPUS recognised format, and stores the data in secure generic data containers (GDC).
Test scripts which are centric to the functional tests tools, contain the user actions captured on the application under test (AUT), and contain all the necessary information to perform testing. OPUS uses these scripts and other repository information in a specific format as input. The NCD is then derived from these scripts by OPUS, in a unique format which contains test, configuration and control data.

### Refer FIG. 12: Non Application Centric Data

2. Generic Data Containers (GM)

OPUS uses Generic Data Containers to store its data. GDC are a finite set of tables with no specific field names, but with uniform field definitions. The columns are used generically to store the data in a random placement.

3. Intelligent Script Generator (SG)

OPUS Intelligent Script Generator uses the data in the GDC and converts it into scripts which are recognised by the functional testing tools. These scripts are then executed by the FTAT. OPUS can create the test scripts along with the test data, sequence of execution, fail-safe mechanisms, test verification and validation points, test evidence to be captured, and other actions that need to be taken.

The scripts generated will also extract the actual values for the test conditions and store them in the GDC for OPUS to generate results for both on screen display and reporting purposes.

Any single or group of test cases can be selected and run. Their related scripts can be packaged, and data generated, without any change to the original test scripts.

### Refer FIG. 13: Intelligent Script Generator

4. Test Tool Engine (TTE)

OPUS Test Tool Engine takes the output from the ISG to drive the testing tool to perform automated testing. TTE uses the FTAT to execute the scripts in an expected manner. TTE will use the most suitable method for driving the FTAT based on a number of factors including operating systems, development platforms and FTAT capabilities.

### Refer FIG. 14: Test Tool Engine

5. Data Security Algorithms (DSA)

OPUS Data Security Algorithms takes human-readable data as its input. It is first encrypted and then converted into hexadecimal form. The converted hexadecimal data is scrambled by randomly choosing multiple scrambling algorithms, and is then stored in GDC. There are three levels of security implemented by the Data Security Algorithm:
Level 1—Encryption
Level 2—Hexadecimal Conversion
Level 3—Scrambling

### Refer: FIG. 15 Data Security Algorithm

To retrieve the data, the process operates in reverse; OPUS fetches the data from the GDC and unscrambles it. The unscrambled hexadecimal data is converted into encrypted ASCII data. The encrypted ASCII data is decrypted by OPUS before it is used for testing.

6. Advanced Data Change Engine (DCE)

Using OPUS Advanced Data Change Engine, the data used for testing can be changed throughout the test pack, with minimal effort, by entering the existing value and the new value. The new value will be changed in the entire test pack, or selected test case(s)/flows without modifying the script or re-importing/reprocessing them.

OPUS uses the configuration details for identifying the data that needs to be modified, and makes the changes accordingly in the GDC. The changed data is generated as script for subsequent test executions.

7. Dynamic Key Optimizer (DKO)

Dynamic Keys can be used to:
Avoid redundant test steps
Fetch a value generated by the AUT during the execution process that will be used at a later stage.
Minimize the impact due to changes in data

To avoid redundant steps in test cases the Dynamic Key Optimizer is used to group the selected steps in the test cases, and a unique dynamic key is set for each group. The subsequent steps can be called by specifying the dynamic key.

Sometimes, the AUT creates data as a part of the execution, which needs to be validated or reused as inputs for other test cases. The Dynamic Key Optimizer feature can be used in these circumstances to capture the dynamically generated value and use it later.

To minimise the impact of data change, a value can be assigned to a Dynamic Key which can be used across the test pack where necessary. When the test data needs to be changed, the value can be changed in the dynamic key instead of changing it in all the places where the data is used.

8. OPUS Audit Trail (OAT)

OPUS Audit Trail feature is the ability to track changes made to test data that is stored in the GDC. Along with the original and the changed value, OAT also saves the user and system information from where the change is being made, and the date and time of the change.

Using OPUS, users can view the change history and can revert to a specific change if necessary.

9. Multiple Test Configuration (MTC)

OPUS Multiple Test Configuration allows test cases to be grouped and configured based on user preference and the need, purpose, or requirement for testing the AUT. Multiple configurations can be created for the same test pack. Each configuration can have its own synchronisation attributes, fail-safe mechanisms, option to export results to external quality management systems, and can be executed simultaneously as independent units.

An example of how MTC could be used would be to have separate configurations for smoke testing, or the testing of a particular module within an AUT, or grouping of all high priority test cases within an AUT for an emergency fix etc.

10. Extreme Exception Handler (EEH)

Extreme Exception Handler is used to handle exceptions when any power off/system crash happens when OPUS is processing. OPUS has the intelligence to resume the process, within a defined tolerance, from where it had been stopped and continue the automated testing. OPUS uses several exception handling strategies and can handle known and unknown scenarios.

11. Upload Test Results into a Quality Management System

OPUS has the ability to upload the test execution results, with the captured screen shots and other test evidence, into the quality management system (QMS). This happens for every applicable step of the test case and provides a full history of all aspects of the test. See Appendix B for a full list of compatible QMS.

Refer FIG. 16: Upload Test Results into the QMS

12. Test Scheduler

OPUS has the option to schedule the execution process on multiple recognized and compatible machines at a specified date and time. The status can be viewed on a notification icon in the notification tray. The scheduler can also be stopped and rescheduled at any time.

13. Unique Business Process Identifier (BPI)

OPUS has the intelligence to identify the unique business processes in the application. It is capable of grouping the test cases based on their business process flow, and each process will be given a unique Business Process Identifier. The test cases can be ordered, and the automation done more effectively and precisely based on the BPI.

Refer to Appendix C for an example of how a business process relates to a business object and definitions of flow, module and condition, as used within Net Magnus applications.

14. Unique Business Object Identifier (BOI)

OPUS identifies the unique business objects in the application, and automatically generates a unique identifier. The Business Object Identifier is associated with a class within the AUT. This can then be associated with test data and/or test conditions. The BOI can be called from anywhere in the application.

15. Real Time Test Progress Indicator (TPI)

Test progress indicator shows the complete status of the test cases and a description of the current execution process. For each test step being executed, a description of the test and a screen shot is available to view, by selecting from a summary screen.

16. Data Verification Control (DVC)

OPUS Data Verification Control has the ability to verify the business object properties in the application, and also validate the back-end process such as application database verification, file comparison, string comparison etc.

DVC can access multiple applications, across multiple platforms and verify one or more test condition relating to a single test step.

17. Sequence Changer

OPUS Sequence Changer gives the user the ability to change the sequence in which test cases are navigated and the sequence in which test conditions need to be validated, without having the need to generate new test scripts which are dependent on the FTAT.

18. Version Differentiator

The Version Differentiator analyses new versions of applications under test and locates changes in the version's user interface. This assists in gauging the impact of changes and helps better manage existing regression suites, and testing of the new version functionality.

The individual functionality delivered by OPUS is bundled into discreet software components. Designers have ensured that the components are very cohesive and are responsible for a single behavior. The cohesiveness of the components alleviates many maintenance hiccups and checks the propagation of side effects as components undergoes changes.

### BRIEF DESCRIPTION OF THE DRAWINGS

FIG. 1: Manual Test Processes

FIG. 2: Functional Test Automation Process

FIG. 3: Functional Test Automation Process using OPUS

FIG. 4: Manual Test Deployment Diagram

FIG. 5: Functional Test Automation Deployment Diagram

FIG. 6: OPUS enabled Test Automation Deployment Diagram

FIG. 7: FTAT based test automation

FIG. 8: OPUS enabled test automation

FIG. 9: Comparison between Automation SDLC and OPUS enabled Automation SDLC

FIG. 10: Business Process Flows and Sub Components (Modules)

FIG. 11: Overview of OPUS

FIG. 12: Non Application Centric Data

FIG. 13: Intelligent Script Generator

FIG. 14: Test Tool Engine.

FIG. 15: Data Security Algorithm

FIG. 16: Upload test Results into the QMS

FIG. 17 Showing the properties of the flow as associations

FIG. 18 Showing the properties of the module as associations

FIG. 19 Showing the properties of Screen, Class and Field as associations

FIG. 20: Relationship between Business flow and application GUI

FIG. 21: Component Diagram

FIG. 22: Deployment Diagram

FIG. 23: Activity Diagram

FIG. 24: Generation Sub components

FIG. 25: Configuration Sub components

FIG. 26: Data modification Sub components

FIG. 27: Scheduler Sub components

FIG. 28: Execution Sub components

FIG. 29: Version differentiator Sub components

FIG. 30: Activity diagram for generation

FIG. 31: Sequence diagram for testpack creation in generation

FIG. 32: Sequence diagram for application details in generation

FIG. 33: Sequence diagram for module map generation in generation

FIG. 34: Sequence diagram for flowdata generation in generation

FIG. 35: Flowchart for generation

FIG. 36: Activity diagram for configuration

FIG. 37: Sequence diagram for New configuration in configuration

FIG. 38: Sequence diagram for Synchronisation in configuration

FIG. 39: Sequence diagram for Continue exception in configuration

FIG. 40: Sequence diagram for Logout exception in configuration

FIG. 41: Sequence diagram for Customisation in configuration

FIG. 42: Flowchart for configuration

FIG. 43: Activity diagram for Datamodification

FIG. 44: Sequence diagram for add new condition Datamodification

FIG. 45: Sequence diagram for add new step in Datamodification

FIG. 46: Sequence diagram for deleting step in Datamodification

FIG. 47: Sequence diagram for Advanced update in Datamodification

FIG. 48: Sequence diagram for Fine and replace in Datamodification

FIG. 49: Sequence diagram for sequence change in Datamodification

FIG. 50: Sequence diagram for Add new object in Datamodification

FIG. 51: Sequence diagram for Add new module in Datamodification

FIG. 52: Sequence diagram for New dynamic key in Datamodification

FIG. 53: Sequence diagram for Rollback dynamic key in Datamodification

FIG. 54: Sequence diagram for Audit trail in Datamodification

FIG. 55: Flowchart for Datamodification

FIG. 56: Activity diagram for Scheduler

FIG. 57: Sequence diagram for scheduling in Scheduler

FIG. 58: Flowchart for Scheduler

FIG. 59: Activity Diagram for Execution

FIG. 60: Sequence Diagram for Test Preparation in Execution

FIG. 61: Sequence Diagram for Script Generation in Execution

FIG. 62: Sequence Diagram for Test Results in Execution

FIG. 63: Sequence Diagram for Power off Exception in Execution

FIG. 64: Flow Chart for Execution

FIG. 65: Activity diagram for Version Differentiator

FIG. 66: Sequence diagram for test creation in Version Differentiator.

FIG. 67: Sequence diagram for script generation in Version Differentiator

FIG. 68: Sequence diagram for test execution in Version Differentiator

FIG. 69: Flowchart for Version differentiator

FIG. 70: Sequence diagram for Encryption

FIG. 71: foreign exchange portal screen shot

FIG. 72: foreign exchange portal screen shot

FIG. 73: OPUS GUI showing how OPUS converts the QTP scripts to OPUS formats (Step 1)

FIG. 74: OPUS GUI showing Group Test cases configuration (Step 2)

FIG. 75: OPUS GUI showing data modification (Step 3)

FIG. 76: OPUS GUI showing an update condition (Step 4)

FIG. 77: OPUS GUI showing another update condition (Step 5)

FIG. 78: OPUS GUI showing viewing results (Step 6)

FIG. 79: OPUS GUI showing condition details (Step 7)

### DETAILED DESCRIPTION

### Product Engineering

OPUS is built on .Net platform, using C# as the programming language. The designers have adopted OOP approach to design the programs and code libraries. The design is highly modular and layered to achieve high degree of agility and extensibility to accommodate change without breaking the code and the functionality Designers have applied design pattern principles where ever applicable to build application structure from loosely coupled components that interact with each other to deliver the system functionality.

The individual functionality delivered by OPUS is bundled into discreet software components. Designers have ensured that the components are very cohesive and are responsible for a single behavior. The cohesiveness of the components alleviates many maintenance hiccups and checks the propagation of side effects as components undergoes changes.

### Product Architecture

The system architecture provides a high level view of the functional components and sub components and depicts how they communicate with each other. System architecture has been developed using UML, will show the different models of the system such as deployment diagram, component and sub-components.

The core design objective of OPUS evolves around the effective implementation of functional path traversal and investigation of errors arising out of this process. A functional path can also be termed as a FLOW.

A flow will always have a logical start and end point. And, the flow's traversal need not necessarily start and end within the boundaries of one application.

### Refer FIG. 17 Showing the Properties of the Flow as Associations

A Flow may comprise of one or many business processes, which will be termed as MODULE. In other words a Module could be defined as a complete functional sub-unit with well-defined start and end points traversed by the flow. The module composition within a flow is defined.

Generally, multiplicities are defined with a lower bound and an upper bound. The lower bound may be any positive number or zero; the upper bound is any positive number or * (for unlimited). By default, the elements in a multi-valued multiplicity form a set. The modules are associated to the flow in defined manner or ordered fashion. The module is associated with a well-defined set of sub-process/s (back or front-end), which accomplish its defined objective. For example, generation of an XML file might be a backend module, and Transaction initiation can be a front-end module.

### Refer FIG. 18 Showing the Properties of the Module as Associations

The backend modules predominantly deal with procedures and packages, which will be referred in general as Backend Processes (BP). Their front-end equivalents will be termed as Screens. Their objectives, dependencies, error conditions, start and end points are clearly defined.

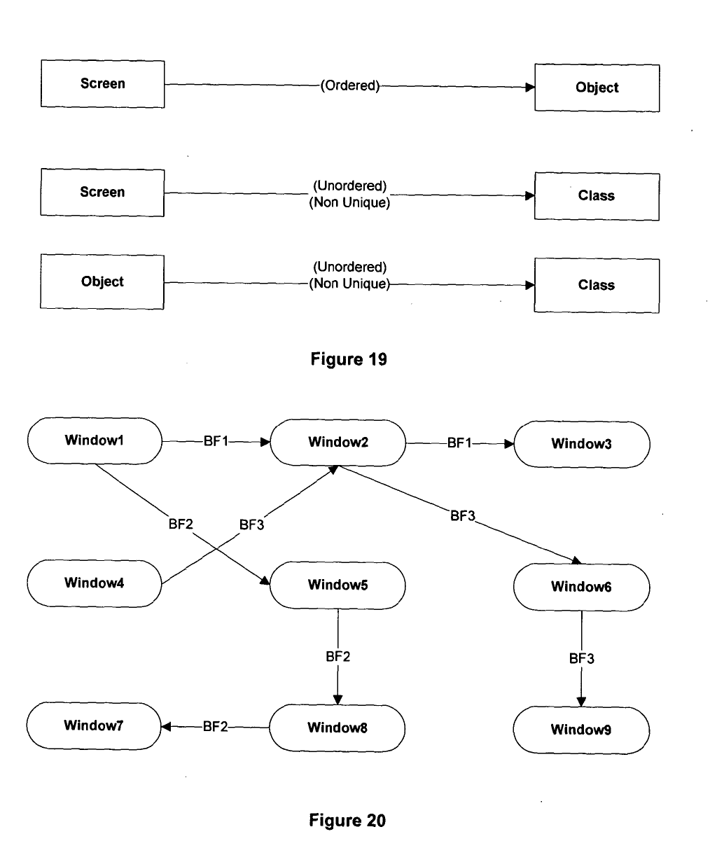

### Refer FIG. 19 Showing the Properties of Screen, Class and Field as Associations

A GUI screen can have multiple fields, which have been termed as OBJECTS at a high level. Every Object has a state and behaviour at any given point. A CLASS is a set of objects that share a common structure and a common behaviour. Classes are useful because they act as a blueprint for objects. In object-oriented design, complexity is managed using abstraction. Abstraction is the elimination of the irrelevant and the amplification of the essential.

For example, a typical Login Module has two objects for taking specific input values from the user e.g. User Name and Password. But, both the objects are of the same Class (edit-set as identified by HP WinRunner for example).

Hence, the design deals with the Functional paths as Flows. The sub-functional processes are defined as modules. Further, the modules are defined as a set of BP's or Screens. And, finally the Screens are further associated with Classes and Objects.

### Refer FIG. 20: Relationship Between Business Flow and Application GUI.

### System Components

The main architectural components of the system are

### OPUS Main

OPUS Main is the core component that acts as a controller and interacts with other components to deliver the functionality

### Generation

The recorded data script is uploaded to OPUS through the generation component, and the data fetched from the recorded inputs (recorded data script) is stored in the GDC in a table format.

### Configuration

This component manages multiple Test component created under a Test Pack

### Data Modification

The data can be modified by using the data modification sub-component.

### Execution

Execution component executes the scripts using the selected FTAT. Execution component re generates the scripts from Module map and Flow data and feeds it to the FTAT.

### Scheduler

The scheduling sub-component is used to schedule the execution for processing, and the test execution sub-component is used to process the required data, and store the results in the GDC.

### QMS

OPUS is capable of uploading Test results to any of the supporting Quality management systems

### FTAT Components

OPUS uses FTAT component to invoke the FTAT and drive the automation

### Results

This is a key component which manages the test results and evidence. Results and evidences are stored in DB tables

### Version Differentiator

Version differentiator uses the Module map and compares it with the information on the newly learned objects of another version of the application and highlights changes

### Database Components

Database component provides Database services to perform as select, insert update and delete operations. This component does not have a sub component

### Component Diagram

Component diagrams provide a physical view of the current model. The component diagram shows the organizations and dependencies among software components. Calling dependencies among components are shown as dependency relationships between components and interfaces on other components. Component diagrams contain Component packages, Components, Interfaces and Dependency relationships.

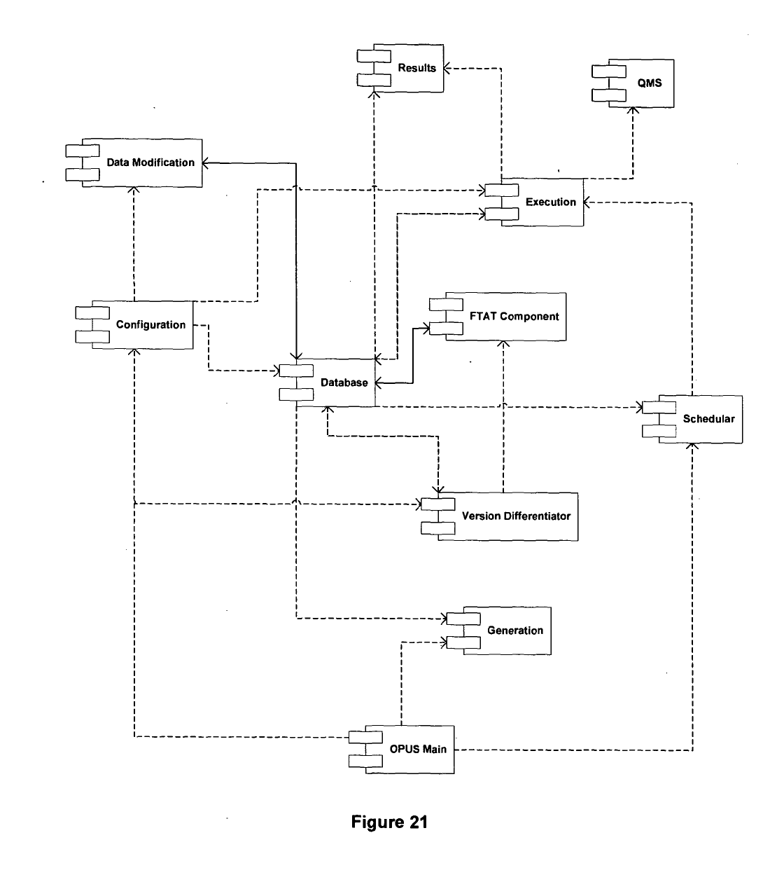

The model shown in FIG. 21 depicts the high-level component breakdown of the OPUS design

### Refer FIG. 21: Component Diagram

### Deployment Diagram

A deployment diagram shows how the OPUS components are deployed in the run-time environment and how they communicate with other software components such as Functional testing tools, Database servers and Quality managements systems

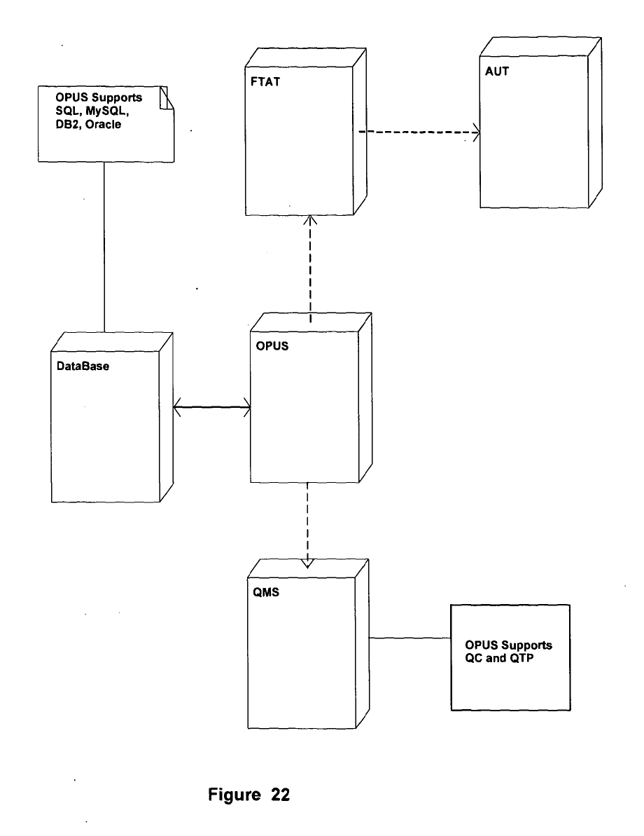

### Refer FIG. 22: Deployment Diagram

### Activity Diagram

The main window that will be displayed with nine high level components:
OPUS Main
Generation
Configuration
Data modification
Execution
Scheduler
QMS
FTAT component
Results
Version differentiator

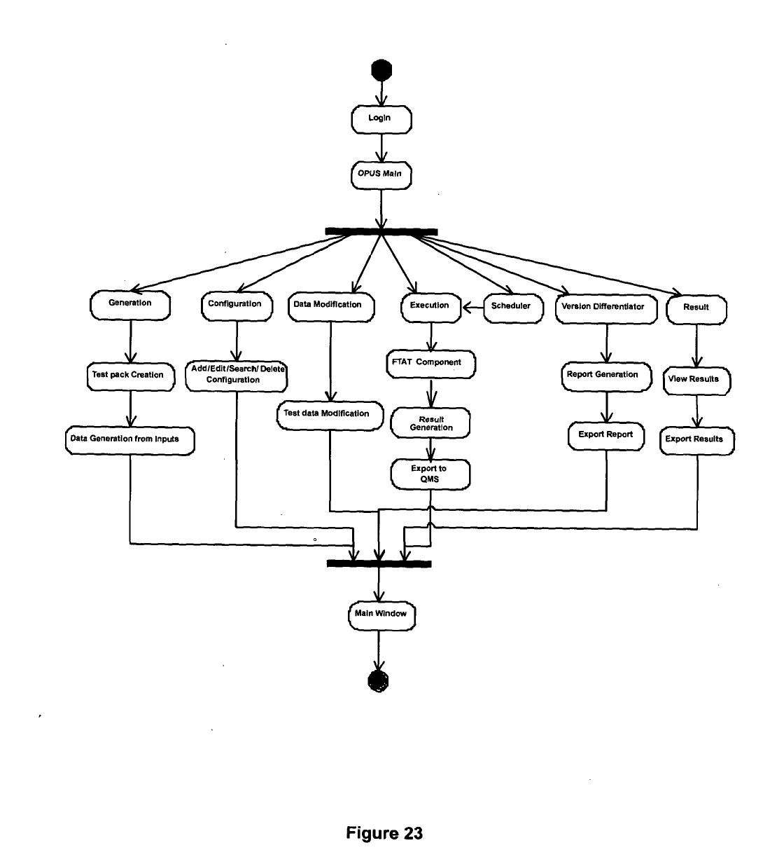

### Refer FIG. 23: Activity Diagram

### Sub System Architecture

A sub system architecture defines the structural components of a component. Each major component described above is made up of a number of related and interacting sub components. Each sub component delivers a distinct functionality.

In OPUS not all components has sub component break down

The following section enumerates the main components and associated sub components with diagrams

### Sub Components

Following are the list of Components and related Sub components which are elaborated in their respective sections

1. Generation
a) Testpack Creation
b) Application details
c) Modulemap Generation
d) Flowdata Generation

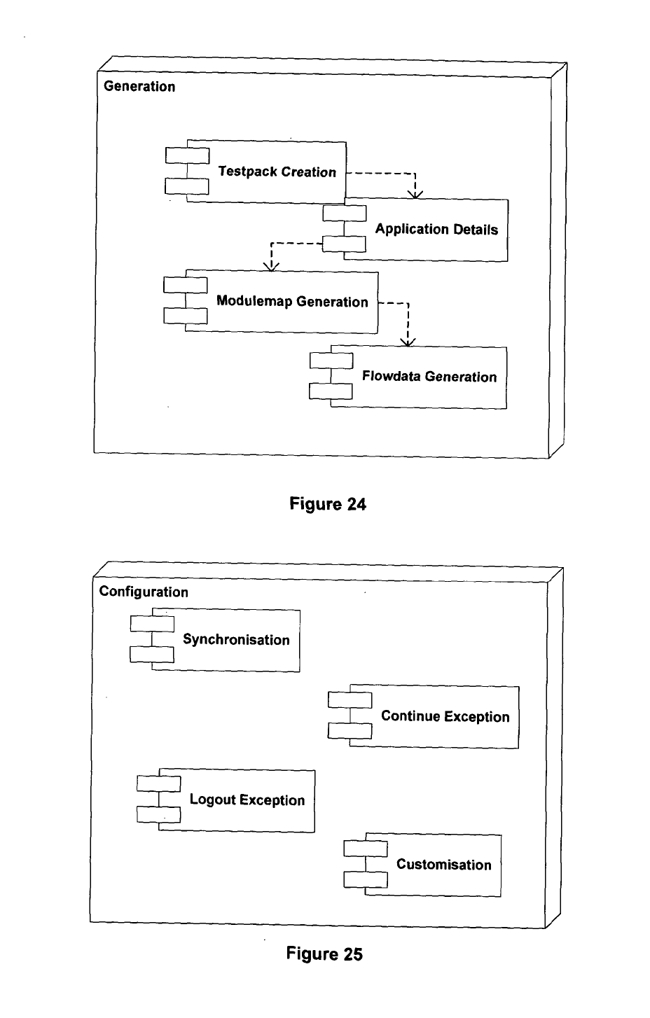

### Refer FIG. 24: Generation Sub Components

2. Configuration
a) New configuration
b) Synchronisation
c) Continue exception
d) Logout exception
e) Customisation

### Refer FIG. 25: Configuration Sub Components

3. Data Modification
a) Add condition
b) Add step
c) Delete step in a Test case can be deleted using this sub component
d) Find and replace
e) Advanced update
f) Sequence change
h) Add new object
i) Add new module
j) Create dynamic key
k) Rollback dynamic key
l) Audit Trail

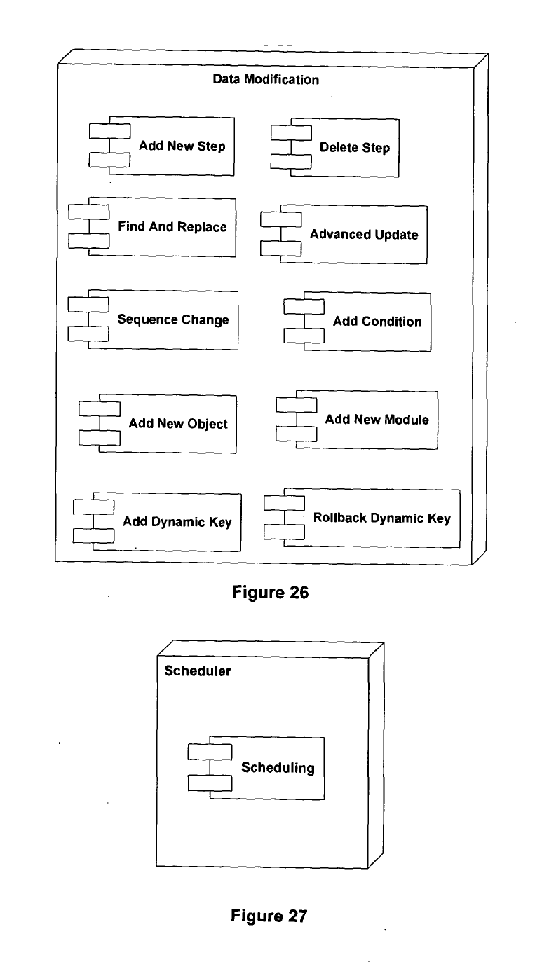

### Refer FIG. 26: Data Modification Sub Components

4 Scheduler
a) Scheduling

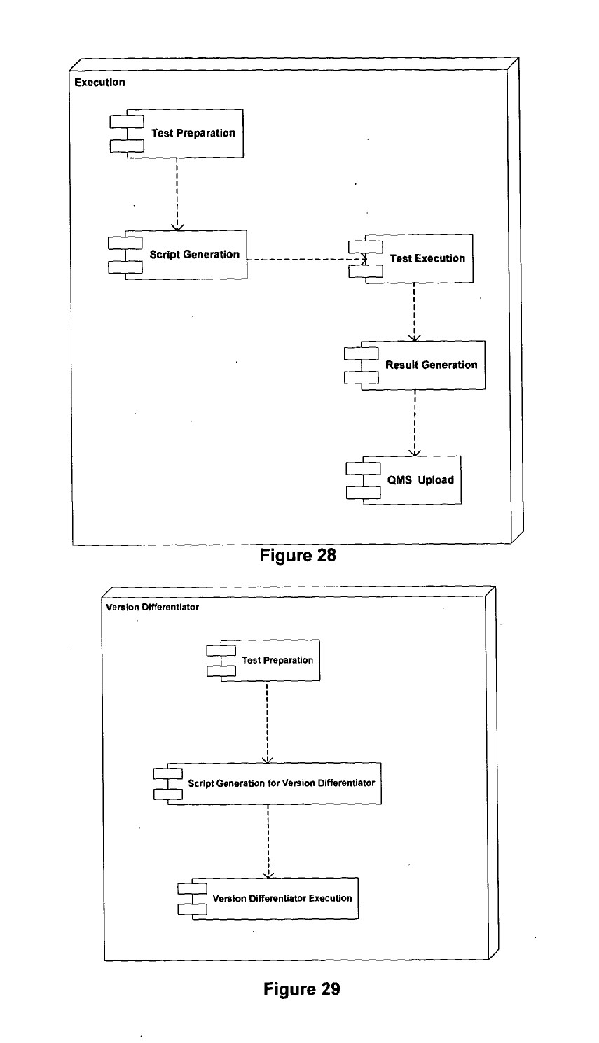

### Refer FIG. 27: Scheduler Sub Components

5 Execution
a) Test Preparation
In this stage OPUS creates the necessary resources which includes Test identifiers for each Test Cases, DB and network connectivity
b) Script Generation
This component retrieves the scramble and encrypted scripts from the GDC and reconstructs the FTAT specific automation script
c) Test execution
This sub component invokes the FTAT to initiate automated testing using the script regenerated by the Script Generation sub component
d) Result generation—Result management is performed by this component
e) QMS Upload
Test results are uploaded to the supported QMS. This sub component interfaces between OPUS and QMS tool

Refer FIG. 28: Execution Sub Components.

6 Version Differentiator
a) Test creation
b) Script generation for Version differentiator
c) Version Differentiator Execution

### Refer FIG. 29: Version Differentiator Sub Components

### Generation

During generation, OPUS organizes the Test cases into Test Packs. A Test pack consists of one or many Configurations. Configuration in turn consists of individual Test Cases.

OPUS identifies distinct business flows in the AUT by determining the sequence of Windows referred in the Test Case. Multiple Test Cases may cover the same business flow; hence they are grouped under the same business flow.

Business flows and creation of configurations are covered in the later sections.

OPUS creates individual Databases for each Test Pack. Test Pack name and the supporting Database name will be the same. The Test cases are stored in a Test Pack in a format specified by OPUS.

As discussed an individual Database is created for each Test Pack. The Database is then populated with the full schema as per OPUS specification.

### Activity Diagram—Sub Components

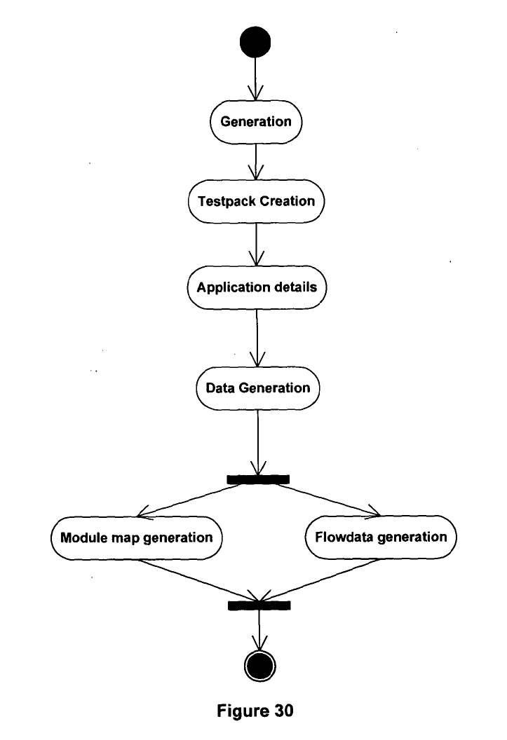

### Refer FIG. 30: Activity Diagram for Generation

### Sub Components

Following is the list of sub components and associated Sequence diagrams

### Testpack Creation

A Test pack is the basic unit of Test asset. A Test pack contains all the GUI objects and business flow information. The key information also includes AUT name, AUT release version, Company name, initial module no and initial flow Id, FTAT tool name and add-ins

For each Test case individual Databases is created in the Test pack name given by the user. User must have privileges to log into the DB server. User is also allowed to choose any of the DB servers supported by OPUS

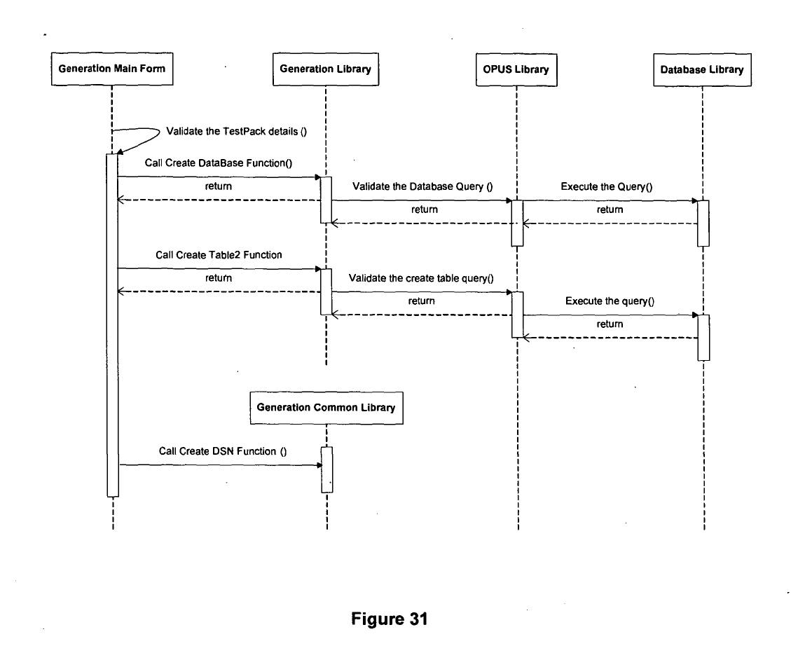

### Refer FIG. 31: Sequence Diagram for Testpack Creation in Generation

### Application Details

OPUS needs to know details regarding the AUT and the FTAT. This includes application path release number name of the FTAT tool, FTAT add-ins FTAT object repository path initial module number and flow id.

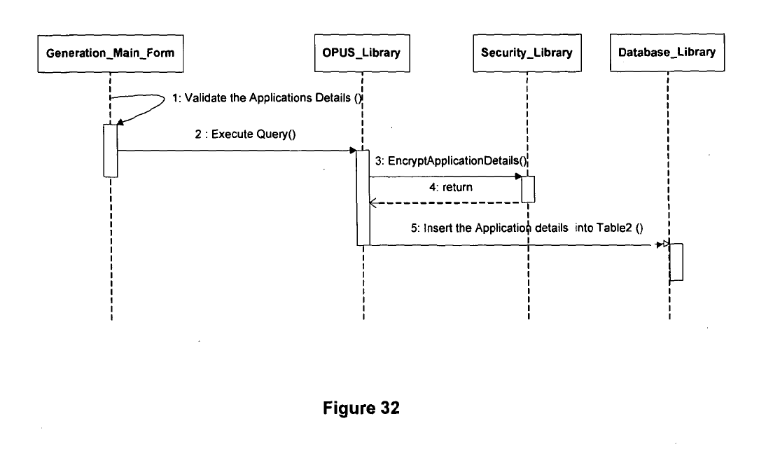

### Refer FIG. 32: Sequence Diagram for Application Details in Generation

### Modulemap Generation

Individual Test Pack includes a Module map. A Module map is a repository that contains information on various windows and associated objects referred in a test script.

Each Window is assigned a unique identifier. Each object found on the window is also assigned a unique identifier. The object identifier consists of two parts. The first part is the module identifier. The next part is a unique serial number which is hyphenated with Module identifier.

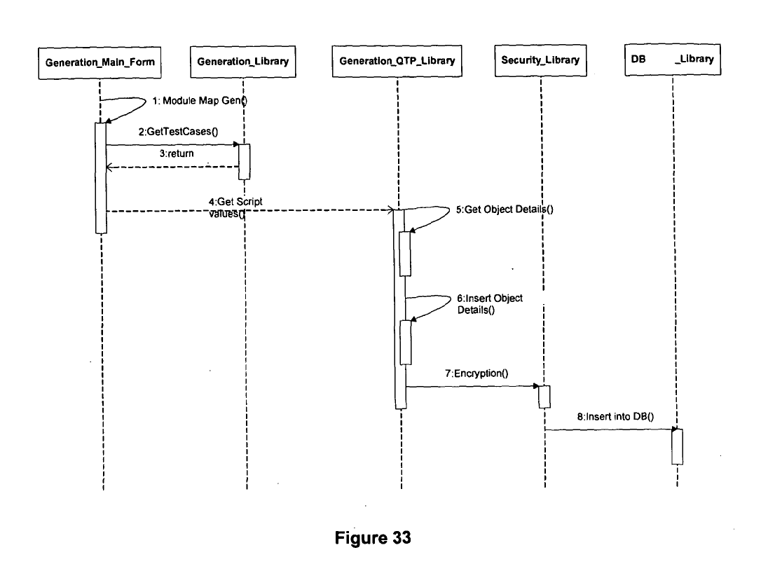

### Refer FIG. 33: Sequence Diagram for Modulemap Generation in Generation

### Flowdata Generation

OPUS processes FTAT scripts to separate information on Objects, data and conditions and store them separately in Table1 and Table3. Data and conditions, which are stored together, are concatenated with a delimiter and stored in the same table.

Steps consisting of objects in sequence are assigned a unique Test Id. A different object ID is assigned to the steps should any of the object reappear in the sequence

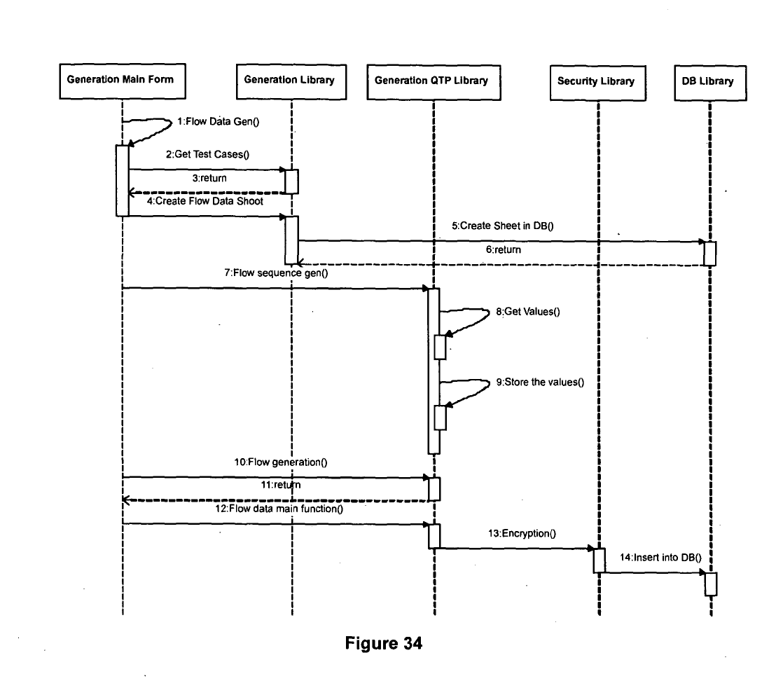

### Refer FIG. 34: Sequence Diagram for Flowdata Generation in Generation

### Product Design

### Flow Chart

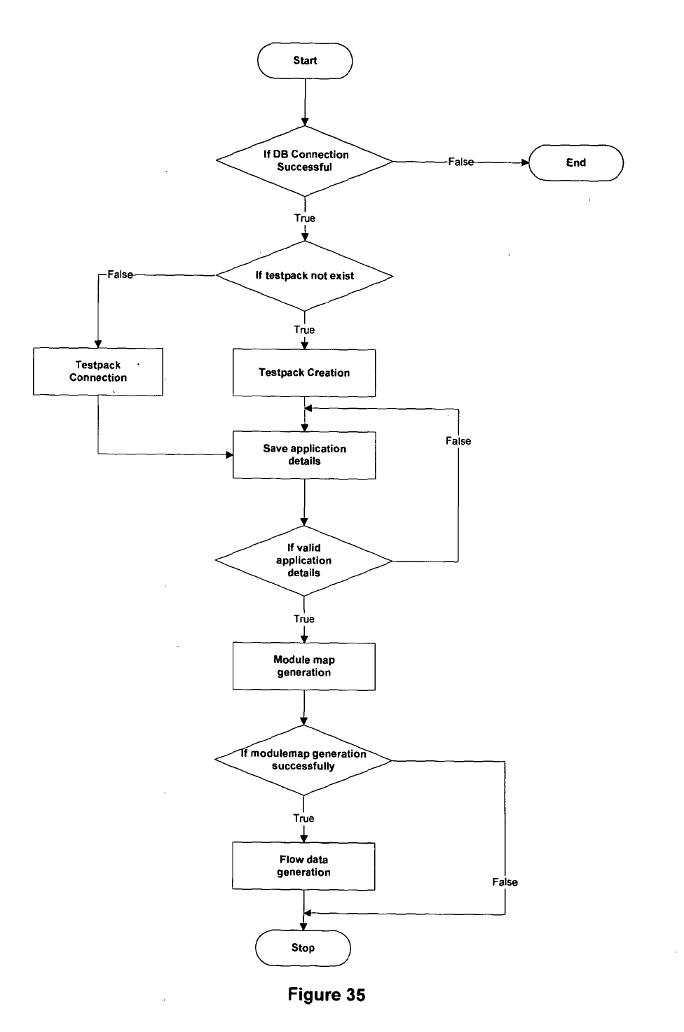

### Refer FIG. 35: Flowchart for Generation

### Algorithm

### Testpack Creation

### Steps:

Object: Generation Main Form

Capture Test Pack Name

Capture User Name

Capture Password (Encrypted)

Select Data source from the Dialog box. System to display existing Network sources.

Select the Testing Tool

Click on Command button (‘Create’) to create a new Test Pack

The event handler of the Command Button to perform the following Task

Validate the following:

Test Pack Name should not be Null

User Name should not be Null

Password should not be Null

Data source should not be Null

One of the Testing tool option is mandatory

If validation succeeds
Call function Create_Database( )

End If

Object: Generation Library

Method: CreateDatabase( )

Connect to Database using the Credentials given above—Test Pack Name, DB Source, User Name and Password.

If successfully connected throw Error Message as ‘Data Base Already Exists’ as Database name must be unique.

Else

Create DSN

Validate query calling the object ‘Generation Library’

Object: Generation Library

Method: Validate the Query( )

Steps:

Validate Query

Object: Database Library

Method: Query( )

Steps:

Create a Database in the name of the Test Pack

If duplicate DB name display error message

On Error creating Database, display error message

Set Test tools add-in.

### Application Details

### Steps:

Object: Generation Main Form

Capture Application Name

Capture Company name

Capture Application Release no

Choose Test tool add-in

Capture the folder path of the script

Capture the QTP object repository path

Capture the initial Module number

Capture the initial flow id number.

Read all the scripts from the folder path specified above.

Insert Test case information into the Database (Table2)

Retrieve Test case information from the Database

If the number of records retrieved I<=0, flash message to re enter the correct scripts path

Display Test case names on the screen

Allow the user to choose the Test cases by selecting them

Before the user input is saved to DB perform the following validation

Display error message if Company name is null

Display error message if Application name is null

Display error message if Application release value is null

Display error message if the number of the selected Test Cases is null

Display error message if initial module id is null

Display error message if initial flow id is null

Display error message if input folder path is null

Display error message if tool repository path is null

Retrieve the ‘add-in’ from the check box and store it in an array

Prompt the user for confirmation before saves.

On confirmation Call OPUSLibrary.ExecuteQuery( )

Object: OPUSLibrary

Method: ExecuteQuery( )

Object: SecurityLibrary

Method: EncryptApplicationDetails( )

### Steps:

Encrypt the following information: Initial module number, Initial flow id and scripts folder path

Encrypt the following information: Company name, Application name, Application release number and Add in details.

Retrieve the repository file from the folder specified.

Convert the data in the file to byte stream

Convert the byte stream data to BASE64 encrypted format

Convert the BASE64 encrypted data using NMSI proprietary algorithm

Store the encrypted Repository data in Table2

Call the method DatabaseLibrary.InsertApplicationDetailsintoTable2( )

Object: DatabaseLibrary

Method: InsertApplicationDetailsintoTable2( )

### Steps:

Insert the following encrypted data into Table2

Initial module number, Initial flow id and scripts folder path

Company name, Application name, Application release number and Add in details.

Object repository

### Module Map Generation

### Steps:

Individual Test Pack includes a Module map. A Module map is a repository that contains information on various windows and associated objects referred in a test script.

Each Window is assigned a unique identifier. Each object found on the window is also assigned a unique identifier. The object identifier consists of two parts. The first part is the module identifier. The next part is a unique serial number which is hyphenated with Module identifier.

As explained, a window is uniquely identified in the Object Repository.

Retrieve the following data from Table2 of the Test Pack Database and store them in Data row Collection

1. Application Name

2. Company name

3. Application Release no

4. Test tool add-in

5. Folder path of the script

6. QTP object repository path

7. Initial Module number

8. Initial flow id number.

If the number of rows returned is <1 flash error message

Else
Retrieve values for the above mentioned data and store it in respective variables.
Call the Module map generation Routine to generate Module map information.

End If

Object: GenerationLibrary

Method: GetTestCases( )

Get all the selected Test Case names from the Database

Call GenerationQTPLibrary.GetScriptValues( )

Object: GenerationQTPLibrary

Method: GetScriptValues( )

FOR EACH Test Case Name in the Data set

Read the script from the specified path and store it in array
FOR EACH element (line of script) in the array

From each line extract the following

Window type and logical name

Object type and logical name

Each window will be assigned a unique identifier

An object on the window is identified by the window it is associated with, object logical name and object class.

Each object on the Window is assigned a unique identifier (Object ID)

Object ID consists of Window id and Object id separated by hyphen.

The first object on the Window is a dummy object which has the object id made up of Window Id and Window logical name.

The second object is also a dummy object that's assigned an object id of 2 prefixed by Window name

All other Window objects are assigned ids starting from 3 and prefixed by Window id Insert the following into Module Map in the Database, after encryption

1. Module No

2. Window type and logical name

3. Object type and logical name
END FOR

END FOR

### Flow Data Generation

### Steps:

Object:Generation Library

Method:Get TestCases( )

Retrieve from the Table2 all the stored Testcases selected by the user for the Testpack

FOR EACH TEST CASE
Read the Test case into an array
Call CreateFlowDataSheet( )

END FOR

Method: CreateFlowDataSheet( )

Create Flow data table

Retrieve the last Test Id value from the Database

Increment the value by one.

Object:GenerationQTPLibrary

Method: FlowSequenceGeneration( )

FOR EACH SELECTED TEST CASE

Read a script line

Create arrays for storing Window, object, data and checkpoints information

Separate Window, object, data and checkpoints and store it in an array

Get object ID from the Module Map

Get checkpoint information for the object for the window from the script's results log file.

Assign Window name to a string variable if not already assigned.

Return the business flow string

Return object id array and Data condition/value array

END FOR

Method:FlowGeneration( )

Retrieve business flow string explained above

Take the string

Break it up into individual windows

Get module id for each window

Concatenate all the module Ids

Check in the Table2 if the flow already exists

If exists
Append the current Test case name to the existing flow
Update Database with the new value

Else

Create a new flow with the module sequence and add Test case name\

Insert into DB

End if

Return Module sequence

Method: FlowDataMainFunction( )

Within a Test Case a set of steps consisting of unique window objects references in a sequence is assigned a unique step id. A new step id is generated should any window object reference in the sequence reappear in the test step or a new Window is referred in the test step. Hence in the database table a test id represents a series of test steps concatenated into a string. However each test step is demarcated by a unique delimiter.

In sum each instance of object reference in a Test Case will have unique Test Id. This is very important as data and checkpoints may vary with different instances of the same object within the Test Case.

This representation of test step facilitates easy retrieval, insert and modification of test steps in opus.

### Example

| Test | | | |
|---|---|---|---|
| Id | Test Steps | Window | Object |
| 1 | 1 | W1 | Obj1 |
| 1 | 2 | W1 | Obj2 |
| 1 | 3 | W1 | Obj3 |
| 2 | 4 | W1 | Obj1 |
| 2 | 5 | W4 | Obj1 |

Maintain two arrays for object id and data value and conditions

Maintain string for Module sequence returned from the above function

Generate a Test Id

Encrypt and save the values in the two arrays to the Flow data tables in the Database (Table1 & Table 3)

### Configuration

A Test configuration is defined as a collection of Test cases that are executed to test a functional area in the AUT. A Test Pack typically encompasses a number of Test Configurations and each configuration may contain one or more Test cases.

A functional area in AUT can be sub divided into functional modules. Functional modules are sub divided into Business flows. A Business flow in turn consists of a number of AUT user interfaces or windows that provide a certain functionality to the user. As far as OPUS is concerned a AUT UI/Window is the granular unit for testing.

OPUS demands that automation test scripts are organized and stored in system folders that correspond to different module in the AUT. Hence Test scripts developed to cover a particular module will invariably be closely related and may overlap while covering application functionality

OPUS smartly identifies business flows within the system by observing the sequence of Application windows referred while recording the script. Test Cases which refer the same sequence of Application windows fall under the same business flow.

On the screen where testers create the test configurations, the system should list the modules, the corresponding business flows in each module and all the test cases that map to a business flow.

### Activity Diagram—Sub Components

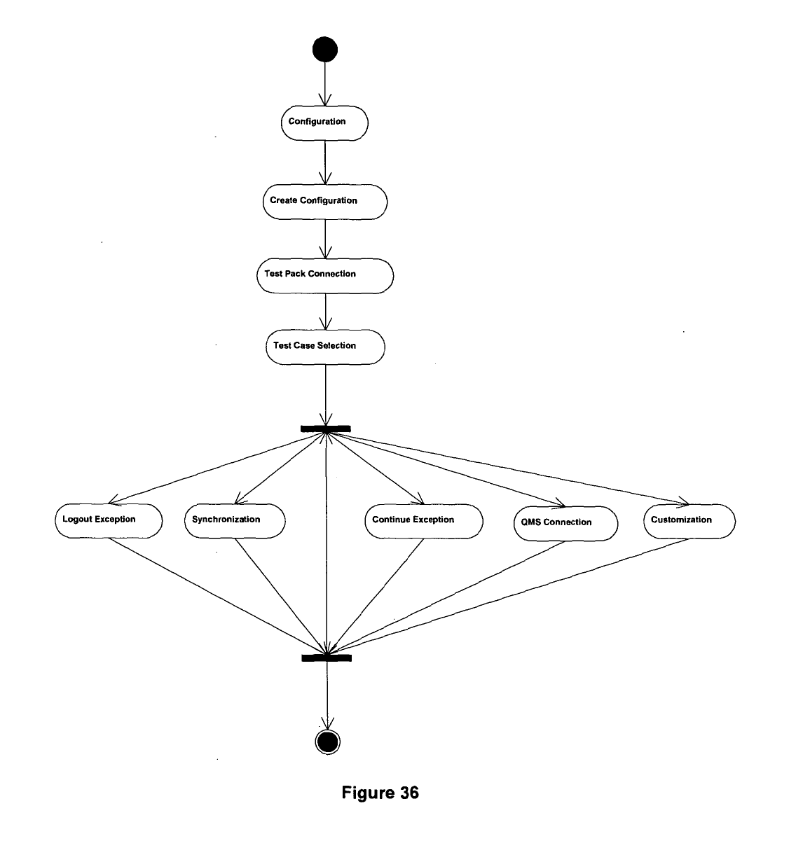

### Refer FIG. 36: Activity Diagram for Configuration Sub Components

Following is the list of sub components and associated Sequence diagrams

### New Configuration

A Test configuration is defined as a collection of Test cases that are executed to test a functional area in the AUT. A Test Pack typically encompasses a number of Test Configurations and each configuration may contain one or more Test cases. This component allows the user to create configurations

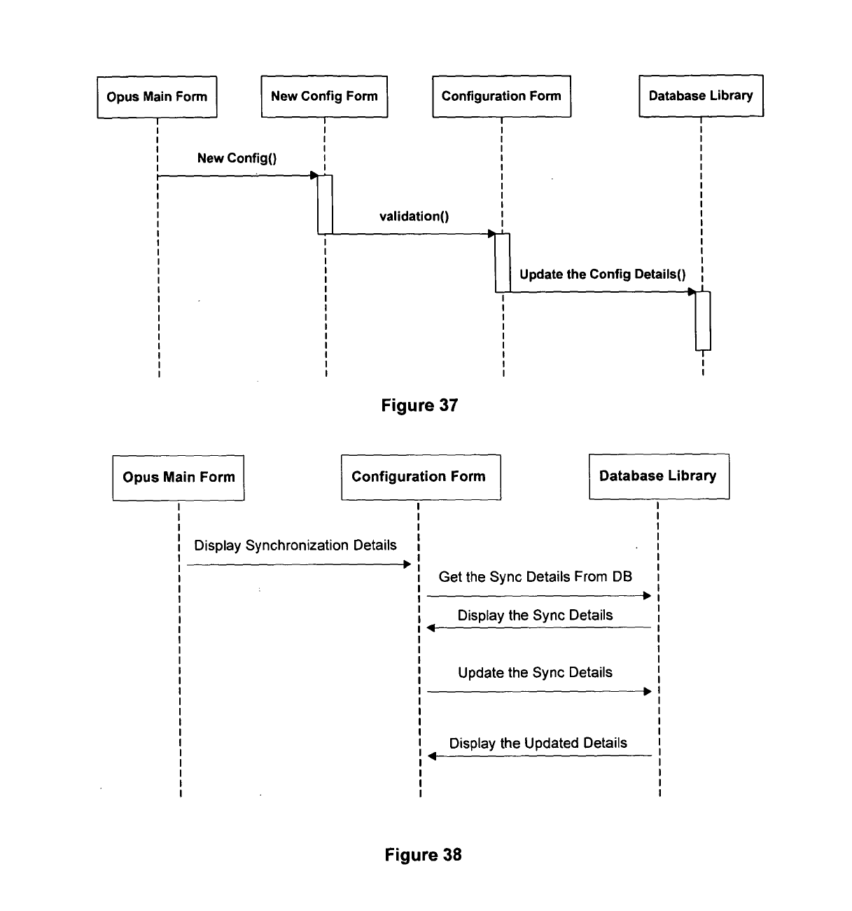

### Refer FIG. 37: Sequence Diagram for New Configuration in Configuration

### Synchronisation

This allows configuration of object wait time for the state of an object to be set

### Refer FIG. 38: Sequence Diagram for Synchronisation in Configuration

### Continue Exception

This sub component allows the user to define the parameters to handle run time exceptions that may occur during test execution

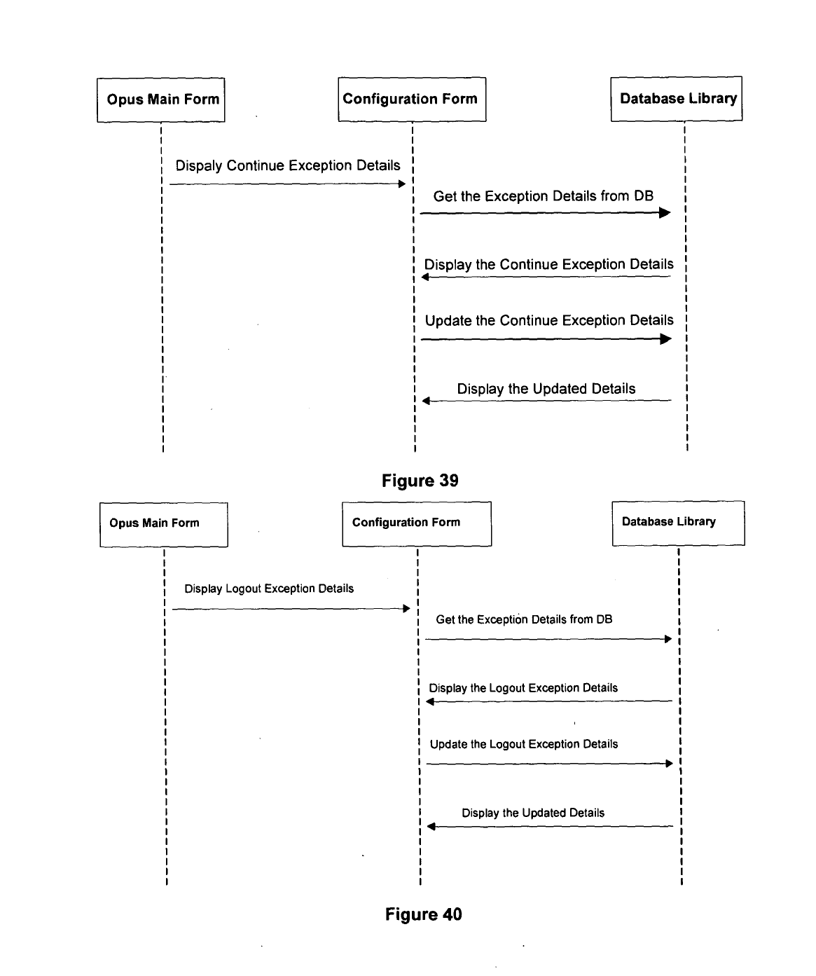

### Refer FIG. 39: Sequence Diagram for Continue Exception in Configuration

### Logout Exception

The sub component allows the user to define the log out scenario when the FTAT comes across a situation which necessitates the user to log out.

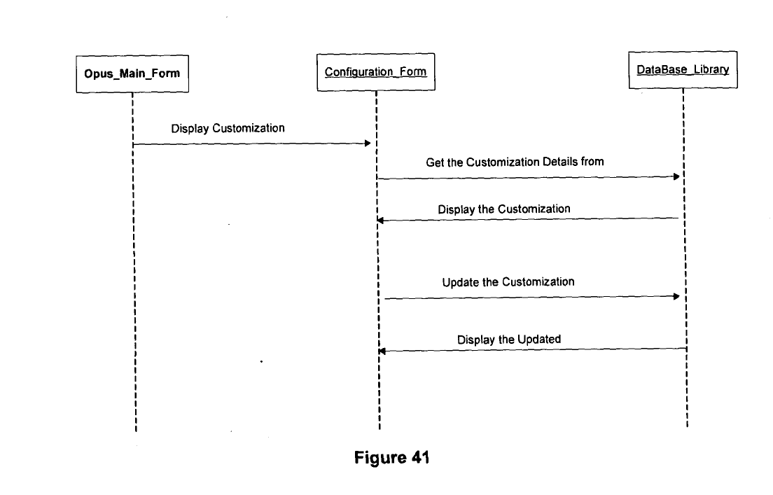

### Refer FIG. 40: Sequence Diagram for Logout Exception in Configuration

### Customisation

Customisation sub component allows the user to edit the module, flow & condition names.

### Refer FIG. 41: Sequence Diagram for Customisation in Configuration.

### Product Design

### Flowchart

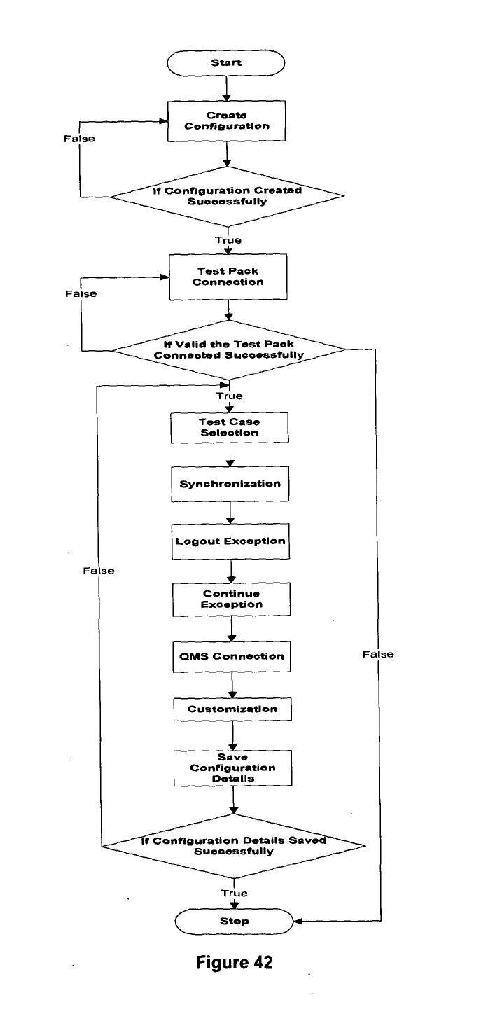

### Refer FIG. 42: Flowchart for Configuration

### Algorithms

Object: OPUS Main Form

User navigates to OPUS Main form

User chooses the option ‘New’

System to display the form to create Configuration

The form contains a Edit box to accept the Test configuration name. The value should not be null. Length not to exceed 25 characters. Check the Database table to ensure that the Configuration name is unique

Throw error in the event of duplicate value.

Return control to Edit Box for the user to enter another value.

OPUS to display the form to capture the following:

User Name

Password

Test Pack Name—Test Pack name is retrieved from the System registry. Registry is update while creating the Test Pack

Data Source

System to display all the DB servers OPUS has access to.

Connect to DB with the above credentials. Display confirmation message on successful connection.

Display error message on failure.

Select Test Cases

Object: OPUS Main Form

User chooses the option to add Test cases to the configuration.

System to display the following information to the user for selection:
Modules—OPUS to display all the modules. The modules are folders where QTP test scripts are organized Each folder contains automated test script to test a particular functionality of the AUT
On choosing the module, the system automatically retrieves the related Test cases under a particular module Also provide option to select all the modules in one shot
Flow.—These are business work flow identified from different test cases. A module may consists of multiple business flows. There might be multiple test cases testing a series of Application windows that make up a business flow. Tester to select the desired business flows.
On choosing the flow, the system retrieves the related Test cases that cover a business flow. Also provide option to select all the business flows in one shot
Test Cases—System to list all the Test cases that relate to a business flow. The user selects the desired Test cases Also provide option to select all the Test cases in one shot

### Data Modification

Data modification is the facility to perform add, edit and delete operations on the following objects
Window—With in OPUS these are representations of the application user interfaces. Each Window object in the Database is assigned a unique identifier. The logical name of the window as assigned by the tool is also saved in the Database.
Objects associated with Windows—In a typical Window based system, a window contains a number of controls. These are Edit boxes, Drop-down lists, Command buttons, Radio buttons and many more. During recording, each control or object is assigned a unique logical name with which the automation tool locates the object on the window during execution. OPUS assigns a unique identifier to each object and saves the object information along with it's logical name.
Data associated with Windows and its objects—A typical test step contains object references, action and also test-data. Test data is entered by the user during test recording. OPUS allows the users to edit the test data, at later stages, on the respective OPUS user interfaces. This obviates the need for the user to edit the FTAT script direct, thereby eliminating the risk of injecting defects.
Data conditions associated with Windows and its objects—Tester may define validation points against any of the Windows or objects associated with it. QTP allows the users to define check points against objects while recording. OPUS allows the user to add some check points not available in the QTP environment.

### Activity Diagram—Sub Components

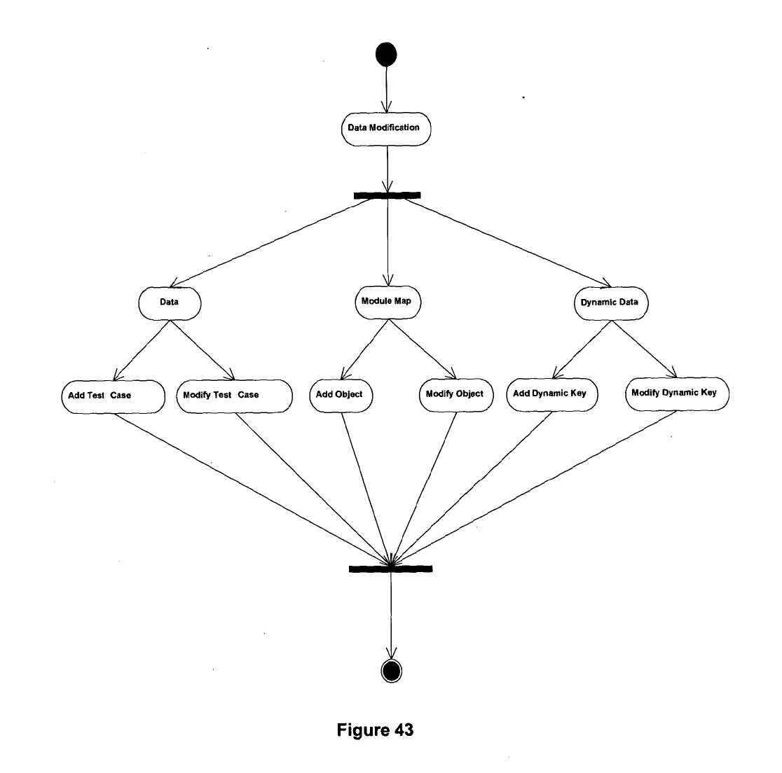

### Refer FIG. 43: Activity Diagram for Datamodification

### Sub Components

Given below is the list of Sub components and their associated diagrams Add New Condition

Conditions are verification points defined against AUT UI objects. Conditions can be defined against a Window or any of the objects on the Window.

Conditions are predefined in the system. User is allowed to select a condition from the drop-down list.

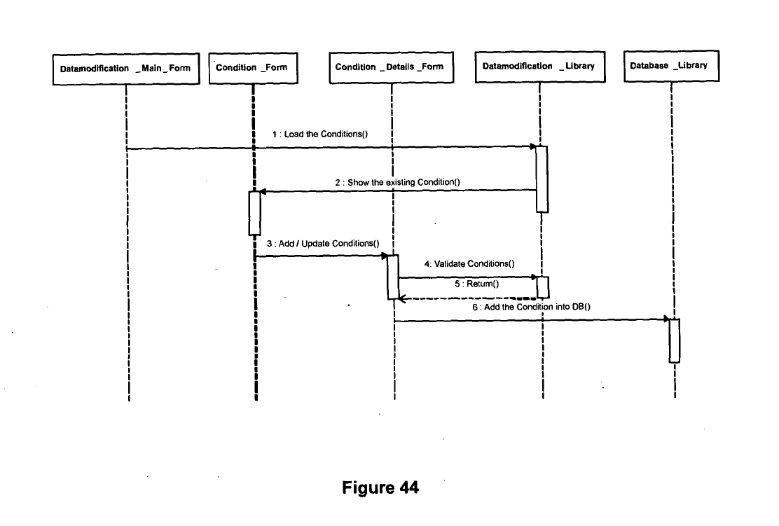

### Refer FIG. 44: Sequence Diagram for Add New Condition in Datamodification

### Add New Step

As the test case is recoded, test steps may refer one or more unique windows in a sequence. All these test steps are assigned a unique test id. Should a test step refer a Window that has already appeared in the sequence, is assigned a new Test id. Test id helps uniquely identify different instances of an objects appearing in different test step. This helps in associating data and conditions with a particular instance of the object.

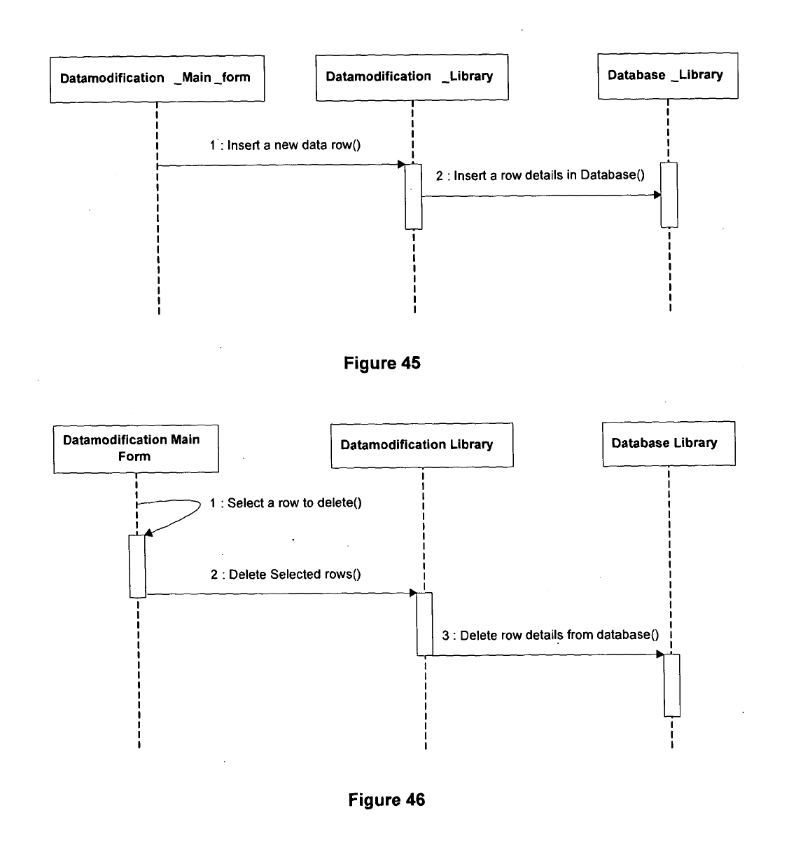

### Refer FIG. 45: Sequence Diagram for Add New Step in Datamodification

### Delete Step

Delete step in a Test case can be deleted using this sub component

### Refer FIG. 46: Sequence Diagram for Deleting Step in Datamodification

### Advanced Update

Test Data can be replaced globally with in a Test Pack. The operation affects all the Test Cases in a Test Pack.

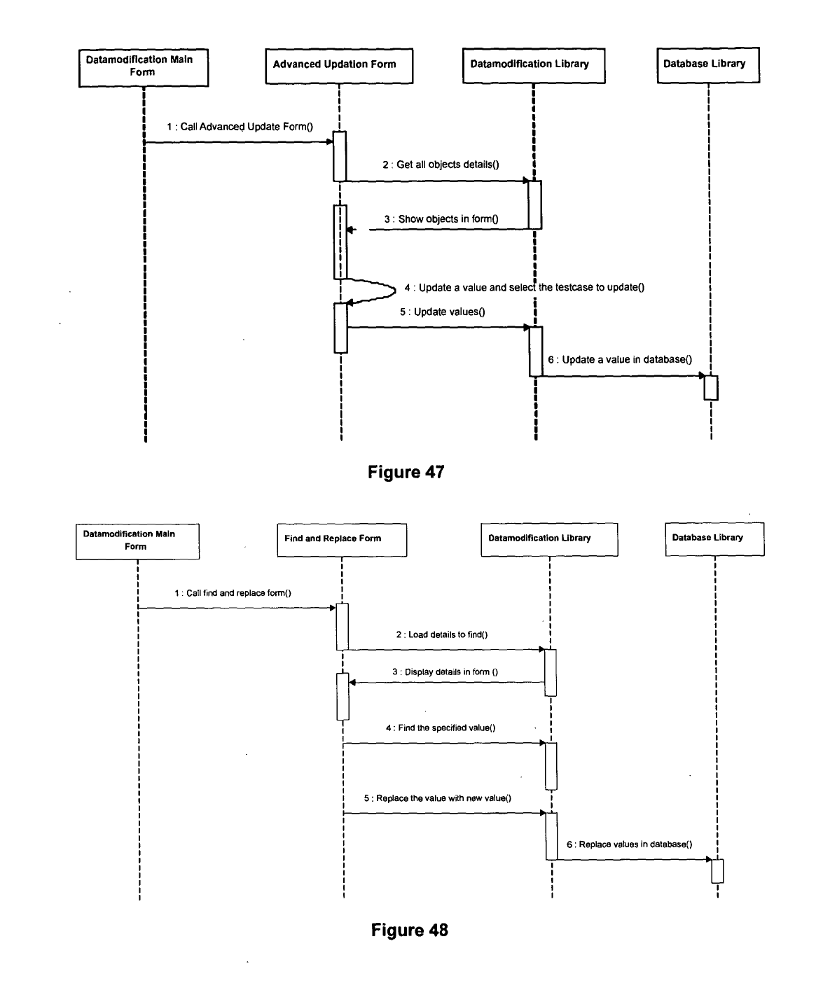

### Refer FIG. 47: Sequence Diagram for Advanced Update in Datamodification

### Find and Replace

This option is to allow users to search for a particular value in the Test Case and replace it with another value. The operation affects all the steps where there are occurrences of the search value.

### Refer FIG. 48: Sequence Diagram for Fine and Replace in Datamodification

### Sequence Change

Sequence of test steps within a Test case can be changed

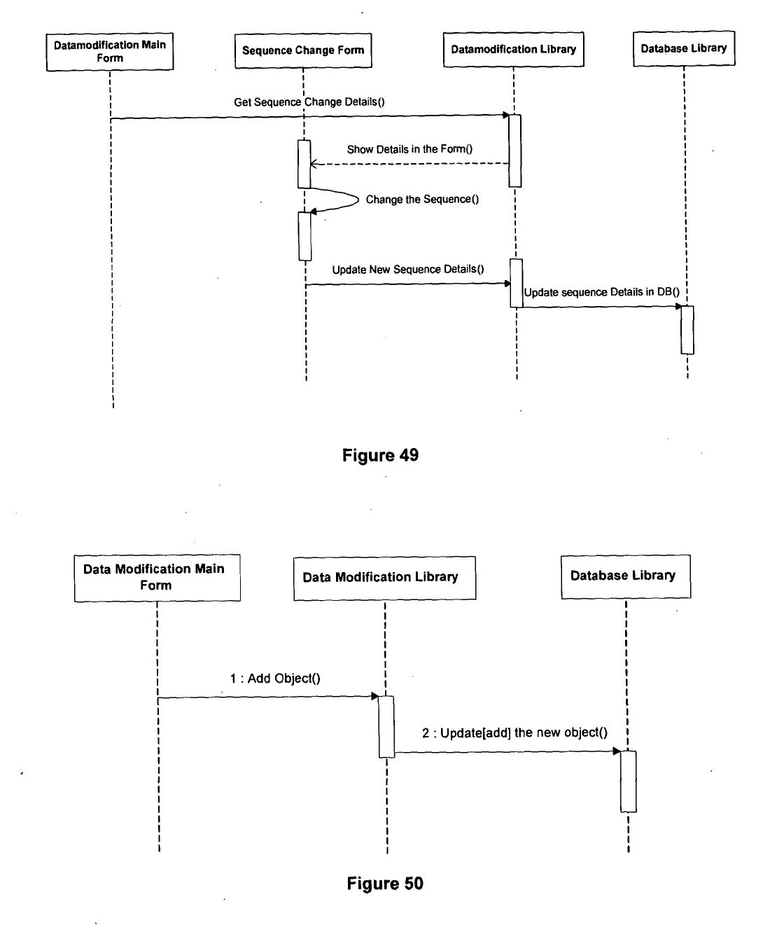

### Refer FIG. 49: Sequence Diagram for Sequence Change in Datamodification

### Add New Object

When the application GUI changes the user can synchronize the Module map in OPUS, using this option

### Refer FIG. 50: Sequence Diagram for Add New Object in Datamodification

### Add New Module

This component is used when the when a new window object has to be inserted in the Module map so that Module map stay synchronized

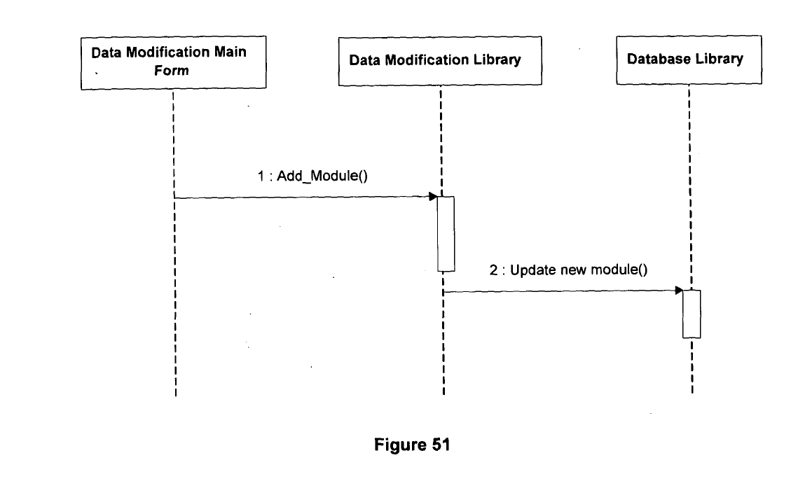

### Refer FIG. 51: Sequence Diagram for Add New Module in Datamodification

### Create Dynamic Key

Dynamic key option allows the user to group common test steps across Test cases in a common container named Dynamic Key. A Dynamic key replaces the original steps. This helps eliminate redundancy and enhance maintenance of Test Cases as amendments to test steps are carried out in Dynamic key, which will reflect it all the Test cases where it's referred.

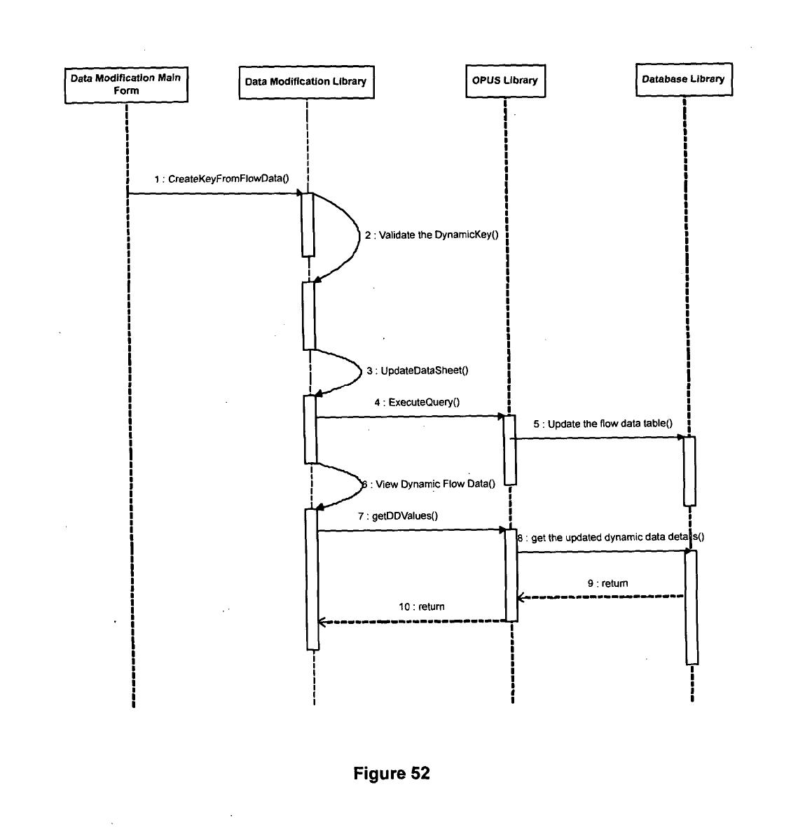

### Refer FIG. 52: Sequence Diagram for New Dynamic Key in Datamodification

### Rollback Dynamic Key

Dynamic keys are optionally assigned to a Test Case to replace a set of test steps as explained above. If required, assignment of dynamic key can be rolled back using this option. In this case OPUS to insert the original test steps.

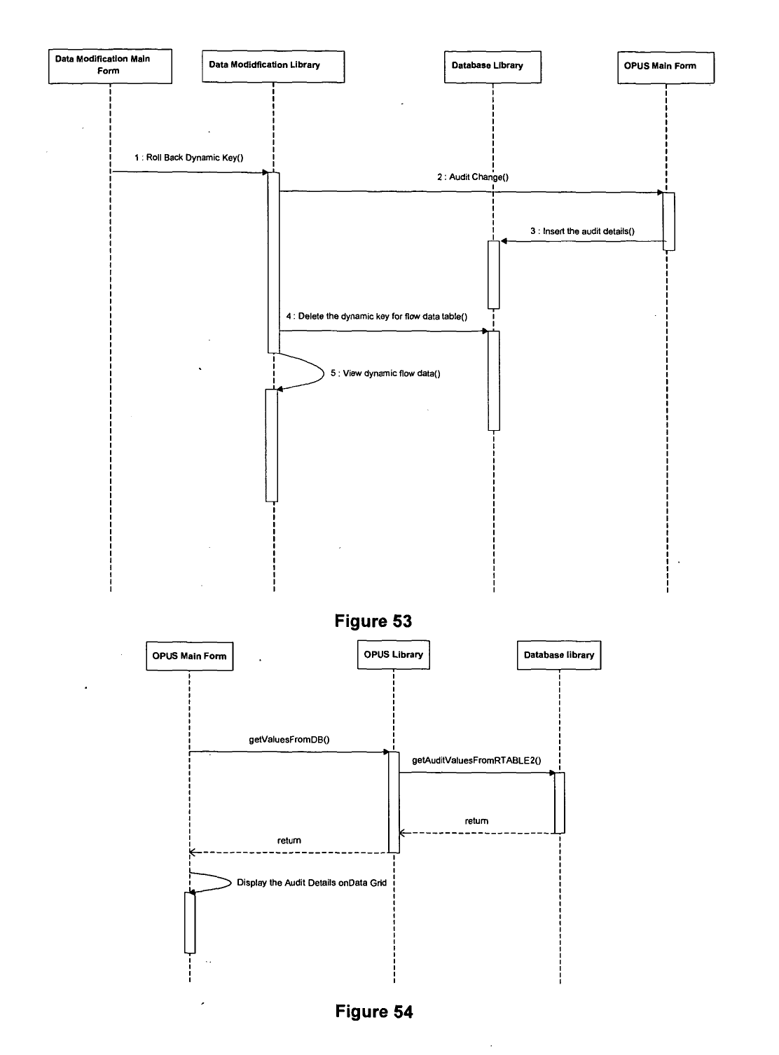

### Refer FIG. 53: Sequence Diagram for Rollback Dynamic Key in Datamodification

### Audit Trail

OPUS Audit Trail feature is the ability to track changes made to test data that is stored in the GDC. Along with the original and the changed value, OAT also saves the user and system information from where the change is being made, and the date and time of the change.

Using OPUS, users can view the change history and can revert back to a specific change if necessary.

### Refer FIG. 54: Sequence Diagram for Audit Trail in Datamodification

### Product Design

### Flow Chart

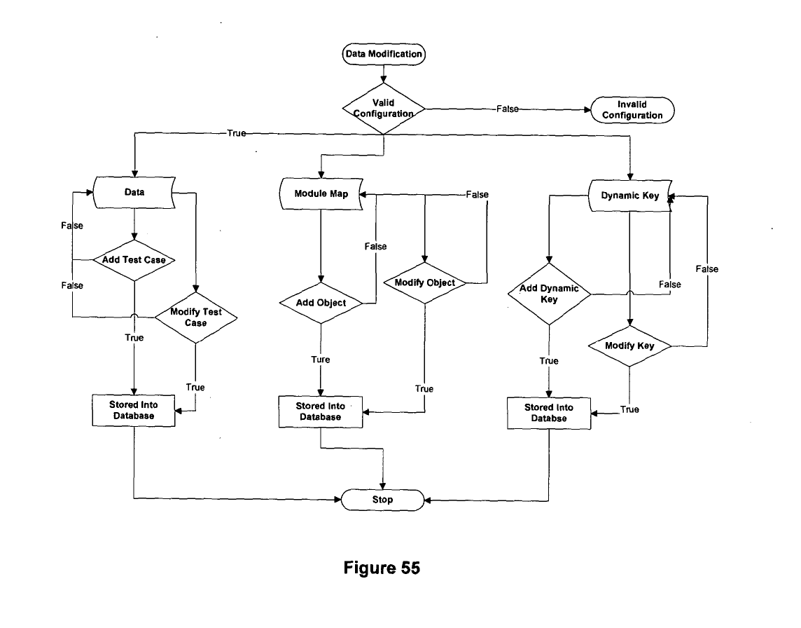

### Refer FIG. 55: Flowchart for Datamodification

### Algorithms

Add New Condition

### Add New Step

Navigate to DataModification main form

Choose the option to insert new step

Call object DatamodificationLibrary.Insert a new datarow( ) method

Object: DataMOdificationLibrary

Method: Insert a new datarow( )

System displays the screen to insert a new step.

User places the cursor on the data grid where he wants to insert a new row.

User selects the following from the respective drop-down list:

Window object identifier

The System to list all the Window objects stored in the Module map

Object identifier

The System to list all the objects, associated with the selected window, stored in the Module map

Data

User enters data. The system to validate for null

Action

The system lists all the action associated with the selected object.

On confirmation

Read Flow data table up to the record after which the new step has to be inserted

Retrieve the last Test id and increment it by one

Assign the newly generated Test id to the new test step.

Append the new Test step to the last retrieved step sequence.

### Delete Step

User navigates to Datamodification main form

Select the row to delete

Call Data modification Library.Deleteselected rows from the grid

On confirmation call DatabaseLibrary.DeleterowdetailsfromDatabase( ) to update the Table

System to allow the user to delete any of the Test step. However there must be a minimum of one test step in a Test case.

### Advanced Update

### Find and Replace

User navigates to DatamodificationMainForm

Initiates the search and replace operation by calling Find and Replace Form

User enters the search and substitute values in the dialog box displayed by the system

Calls DatamodificationLibrary.LoadDetailsToFind to load details

Calls DatamodificationLibrary.FindThe SpecifiedValue

Calls DatamodificationLibrary.Replacethevaluewithnewvalue( ) to replace the occurrences of the search string with the new value.

### Sequence Change

User navigates to Datamodification Main Form

User invokes the option to change the order of the test steps

DatamodificationMainForm calls the

DatamodificationLibrary.GetSequenceChangeDetails( )

DatamodificationLibrary.GetSequenceChangeDetails( )

The method DatamodificationLibrary.GetSequenceChangeDetails( ) returns the Test case details to be displayed

Calls DatamodificationLibrary.GetSequenceChangetheSequence( )

DatamodificationLibrary.GetSequenceChangetheSequence( )

User selects the Test Case he wants to perform the operations on. The system displays the Test step on the data grid.

User places the cursor on the test step on which he wants to effect sequence change.

The system to display a dialog box. The Dialog box to have sections.

The left section displays the current order of the objects on the referred window in the step

The right section contains a text box which the user uses to define the order

User selects the object on the left panel and click on the command button in between the sections to move the object to the text area in the right section.

Call DatamodificationLibrary.update new seq details( )

DatamodificationLibrary.update new seq details( )

Before save the system to check if all the objects have been moved to the new order. DatabaseLibrary.UpdateSequencedetailsInLibrary( )

Save the changes to Database.

Update the flow data to reflect the new order of changes.

### Add New Object

Navigate to DataModificationMainForm

Call DataModificationLibrary.Add_Module( )

Object: DataModificationLibrary

Method: Add_Module( )

Accept Object Id of the Window from the drop-down list

Accept logical name of the object in the edit box.

Check for null values. Check for special characters except hyphen.

Check for duplicate of the value entered in the Module map.

Warn the user in case of invalid characters.

Call DatabaseLibrary.Update(add)thenewObject( ) to save

On Save, generate an object ID for the object by hyphenating newly generated object sequence number to the window id.

### Add New Module

Navigate to DataModificationMainForm

Call DataModificationLibrary.Add_Module( )

Object: DataModificationLibrary

Method: Add_Module( )

### Steps:

Accept new Module (window) name (Logical name) from the user

Check full null values and special characters.

Warn the use in case invalid characters

Before saving value in the Module map table check if the object already exists

If module does not already exist in the module map

Generate a unique identifier for the object

Add newly created object id and logical name to the Module map

End If

### Create Dynamic Key

Initially a Dynamic key is created by a grouping a number of test steps in a Tests Case and assigning the set a name. Dynamic Key data is stored in TABLE2

User navigates to DatamodificationMainForm

User selects the test steps to be defined as a Dynamic key

Right click to display the menu

User to choose the option ‘Create new Dynamic Key’

User enters the name of the key and saves.

Calls DatamodificationLibrary.CreateKeyFromFlowData

Object: DatamodificationLibrary

Method: CreateKeyFromFlowData

Steps:

Check if the key exists in the Database.

Call method updataDataSheet( )

Method: updataDataSheet( )

Steps:

Calls OPUSLibrary.ExecuteQuery( )

Insert dynamic key values into Flowdata table.

Call viewDymaicFlowData of DataModificationLibrary—Retrieve the Key value from Database and replace the steps with the Key value/reference

### Rollback Dynamic Key

User navigates to the form ‘DataModificationMainForm. And chooses the relevant option

Call DataModificationLibrary.RollBackDynamicKey( ) This method calls OPUSMainForm.Auditchanges( )

OPUSMainForm.Auditchanges( ) records the event that Dynamic key is rolled back DataModificationLibrary calls DatabaseLibrary.DeletetheDynamic.( ) to delete from flow data table.

Calls ViewDynamicFlowData( ) to view the changes—steps restored.

### Audit Trail

User navigates to OPUS MainForm

Call OPUSLIbrary.getValuesFromDB—this returns audit information from the Database.

Display the Audit

### Scheduler

Scheduler is used to schedule the execution for processing, and the execution component is used to process the scheduled execution. Thus privileged user is allowed to schedule execution in any of the networked systems he has right to access. The OPUS starts execution at the scheduled time and posts results to the central Database. Scheduling is performed by the privileged user.

### Activity Diagram—Sub Components

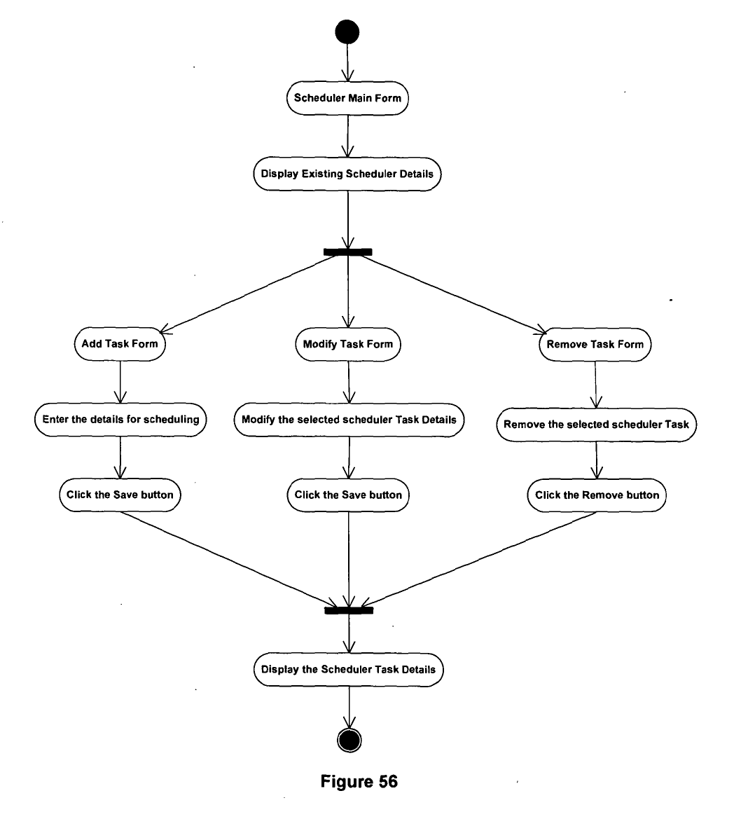

### Refer FIG. 56: Activity Diagram for Scheduler

### Sub Components

Given below is the list of Sub components and their associated diagrams

### Scheduling

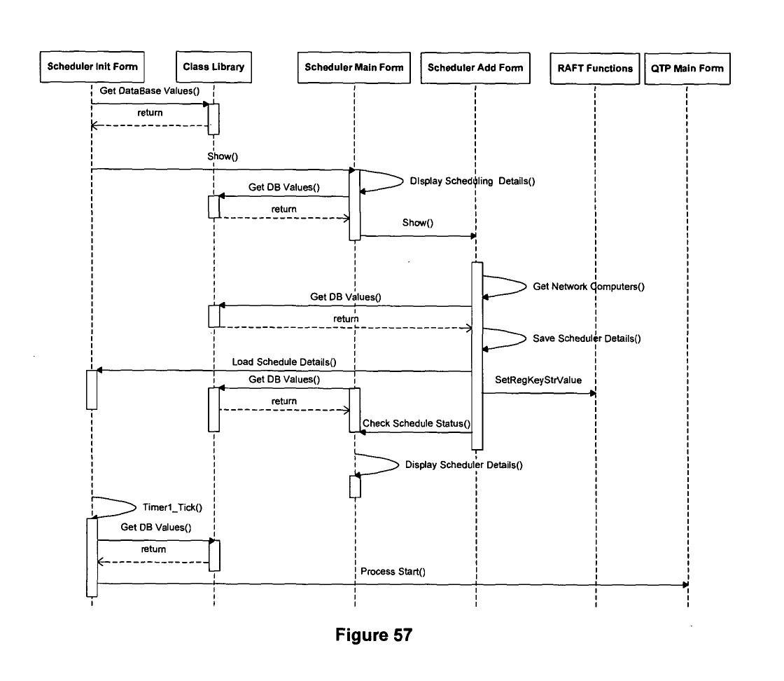

### Refer FIG. 57: Sequence Diagram for Scheduling in Scheduler

### Product Design

### Flow Chart

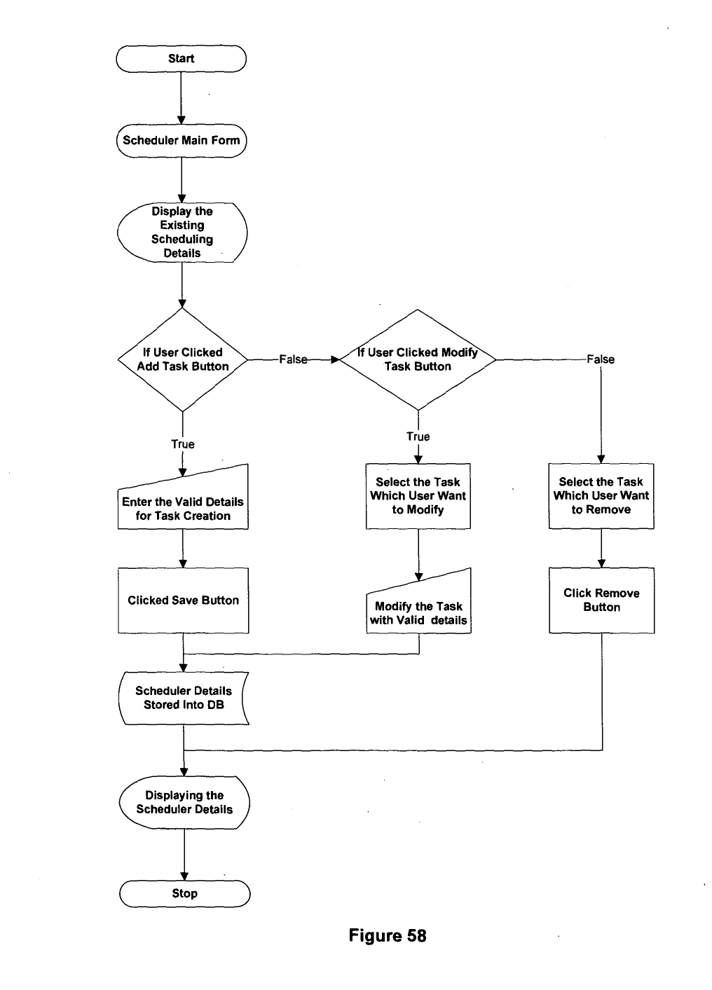

### Refer FIG. 58: Flowchart for Scheduler

### Algorithm

### Scheduling

Get the existing value from database

Call the scheduler main form

Call DisplaySchedulingDetails( ) method in Scheduler main form

Call the add scheduler form

Call the getNetworkComputers( ) method to get list of computers connected in the network.

Give details to add new schedule task

Call saveSchedulerDetails( ) method to save new schedule details

Call loadScheduleDetails( ) method to get the details of schedule task

Call checkSchedulerStatus( ) method to check the status of the scheduler

Check the timer in regular interval to execute schedule task

If timer reached the time call the Execution exe to execute the schedule task.

An change the schedule task status

### Execution

Test Execution is the process by which OPUS executes the selected Test configurations by invoking the appropriate FTAT. Before execution starts, OPUS reads the flow data table. Flow data table holds the original script in a format that OPUS maintains, and quite different from FTAT script format.
To recall, OPUS, during generation, using the FTAT automation script, separates the various objects such as Windows, Window controls, test data and data conditions. The Window and object information is stored exclusively after encryption in a logical repository called Module Map. The information relating to Test data and data conditions are stored after encryption in another logical repository called Flow Data. Both the repositories are supported by two underlying physical DB tables

During execution OPUS re-builds the scripts that lie encrypted, scrambled and stored in different tables. The re constructed script is in the original format that the FTAT recorded during automation of the manual test cases.

To execute the Test script, OPUS invokes the FTAT and transfers to it the re constructed script.

FTAT run the script and post the results and images to a designated directory. At the end of each test script run OPUS collects the results and the associated images (Images highlight the objects for which verification points failed) and upload them to TABLE2 of OPUS Database.

Test results, showing the success/failure status of each test step, are displayed on completion of the whole test. Results are shown in Data grid on the respective Results screen. When the user clicks on the test step OPUS retrieves the associated image from the database to display.

The Test Execution consists of three stages. They are preparation, script generation, execution and results.

OPUS allows the users to execute a Test configuration which contains automated test scripts. Test configurations are contained in Test Packs. User chooses the Test Pack, the Test configuration and Test Cases with in a Test configuration. User can execute only one Test configuration at a time, though he may choose multiple Test cases with in a configuration to execute.

### Activity Diagram—Sub Components

This diagram shows the workflow within the main component and all the sub components involved in the flow

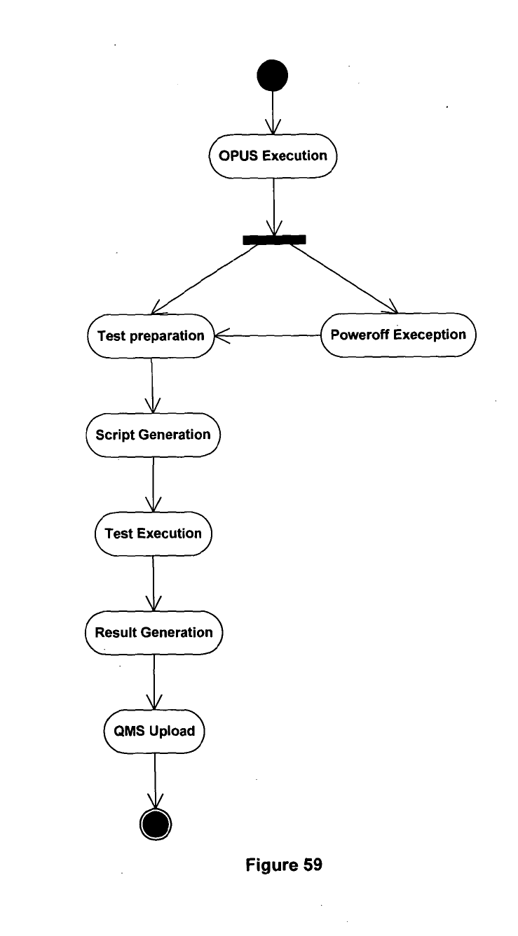

### Refer FIG. 59: Activity Diagram for Execution

### Sub Components

Following is the list of sub components and associated Sequence diagrams

### Test Preparation

In this stage OPUS creates the necessary resources which includes Test identifiers for each Test Cases, DB and network connectivity

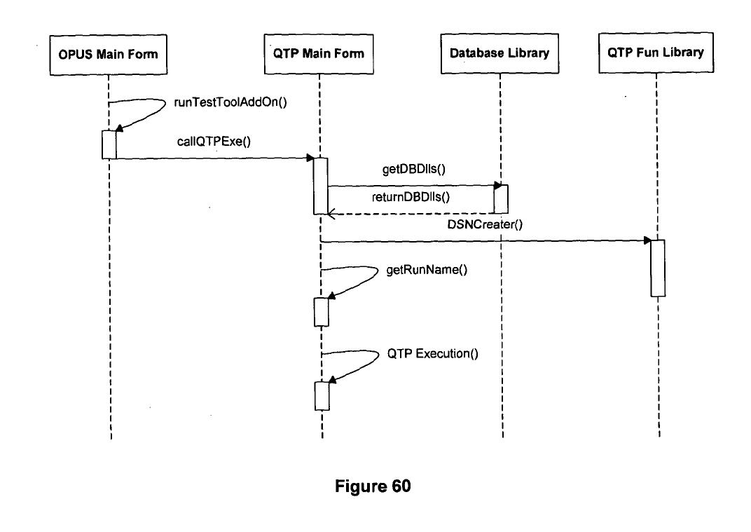

### Refer FIG. 60: Sequence Diagram for Test Preparation in Execution

### Script Generation

This component retrieves the scrambled and encrypted scripts from the GDC and reconstructs the FTAT specific automation script

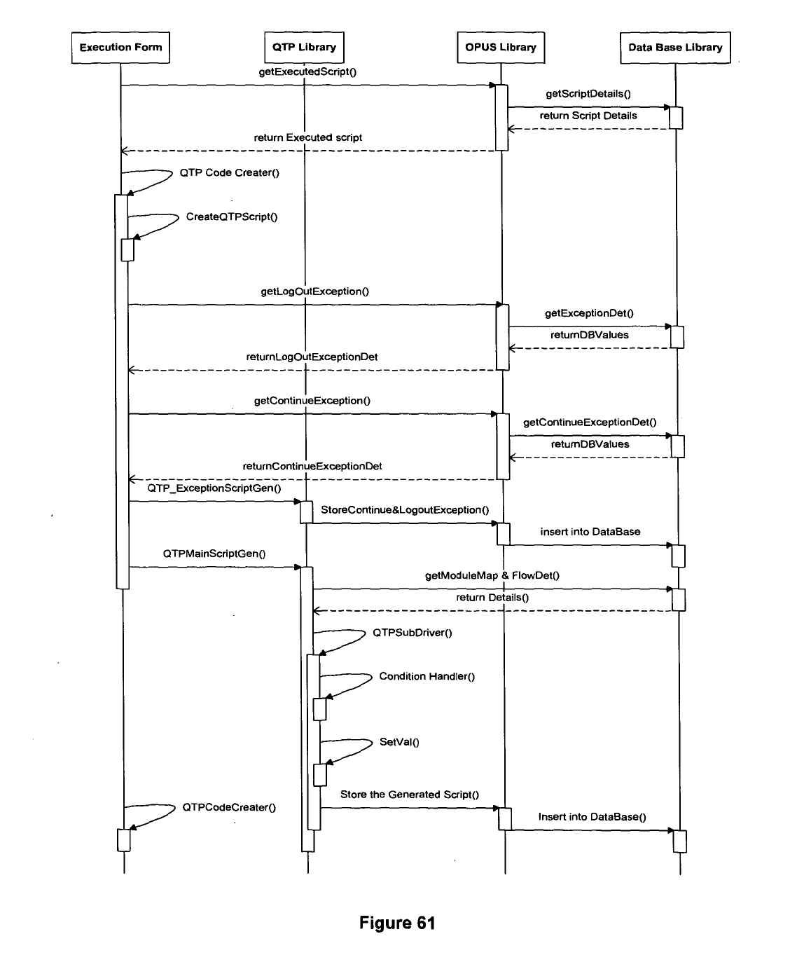

### Refer FIG. 61: Sequence Diagram for Script Generation in Execution

### Test Results

As mentioned in the sections above execution is per Test Case. OPUS evaluates the success or failure of conditions by matching the expected data stored in the Database, with the data generated during test execution, and writes the status to Results Database.

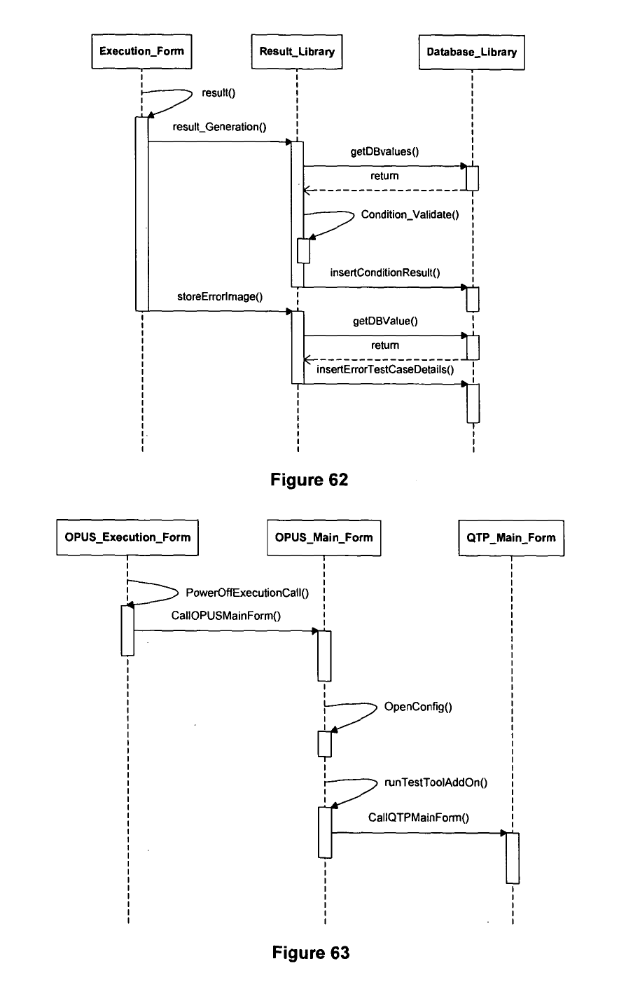

### Refer FIG. 62: Sequence Diagram for Test Results in Execution

### Power off Exception

OPUS is smart enough to learn whether execution is completed successfully or disrupted by any unforeseen events such as power failure.

In the event of aborted execution, when OPUS is launched subsequently, it identifies the Test Case which was not successfully executed. OPUS starts execution from the aborted Test Case and continues till the whole Test Configuration is executed.

### Refer FIG. 63: Sequence Diagram for Power Off Exception in Execution

### Product Design

### Flow Chart

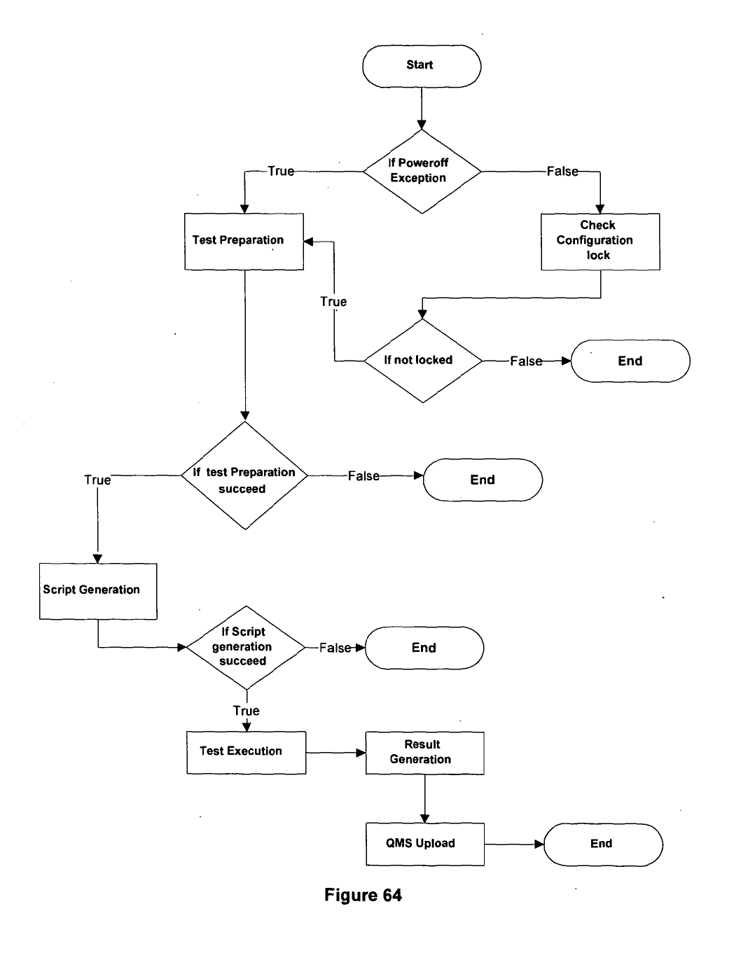

### Refer FIG. 64: Flow Chart for Execution

### Algorithms

### Test Preparation

User navigates to OPUSMainForm to initiate run

User selects Test Pack Test configuration and Test Cases

call runTestToolAddon( ) which calls OPUS_QTP.Exe

OPUS_QTP.Exe QTPMainForm opens up

THis calls DatabaseLibrary.GetDBDIIs

This returns all the objects for the corresponding Database

From QTP Main form call DSNCreate

THis creates a DSN for the Database

QTOMainForm calls getRunName( )

This determines how many times test pack run is run already increment by one and return the run name

QTPMAin form calls QTP Execution

### Script Generation

Execution form calls OPUSLibrary.getExecutedScripts( )

This object calls DatabaseLibrary.getScriptDetails( )

The object retrieves the relevant test cases to be run—selected test cases in configuration

Control return to Execution form

Execution form Calls QTPcodeCreate( ). This method creates the requisite folder structure and the default files

QTPcodeCreate( ) calls createTPScript( ) which re creates VB script for QTP. The scripts are generated as follows

Take the first Test case in the Test Configuration

Identify the objects associated with the Test case, in the Flow data repository

Identify Data conditions associated with the Test Case in the Flow Data repository

Identify action conditions associated with the object identified in the steps above.

Re construct the QTP script by composing objects data and action

Add VB Script Library for the QTP to the generated script

Call OPUSLIbray.getLogoutExceptionDetails( ) to return information regarding unplanned log out

Return control to execution Form

Call OPUSLibrary.getContinueException( ) to get details regarding exceptions encountered during previous run

Return control to Execution Form

Call QTPLibrary.QTP_ExceptionScriptGeneration( ) to generate Generates exception related script

Call OPUSLibrary.continueLogoutExceptionScript( )

This method calls DatabaseLibrary.insert into Database( ) to insert Logout and continue exception data to the Database.

From ExecutionForm calls QTPLibrary.QTP_MainScriptGen( )

This method in turn calls DBLibrary.getModuleMap&FlowDet( )

This method returns Map and flow details

Control returns to QTP Library

Calls QTPSubDriver( )

This method divides script into normal script and condition script If condition script calls Condition handler to generate this generates condition script

Else call QTPSubDriver( )

End If

Calls Setval( ) to generate normal QTP Script

Call OPUSLibrary.storeTheGeneratedScript to invoke DatabaseLibrary to save generated QTP script in TABLE5

Return control to Execution Main Form

### Test Results

Control is with ExecutionForm

Calls result( )

Result( ) method calls Resultlibrary.resultGeneration( )

Resultlibrary.resultGeneration( ) calls getDBvalues( ) to obtain results from TABLE5 (temporary storage)

Return control to ResultLibrary

Calls conditionvalidate( )

This method retrieves data for the conditions and matches with data generated during run to determine pass/fail status of the condition

Control is returned to ResultLibrary

Calls DBLibrary.insert results to TABLE4

Control returns to ExecutionForm

Calls ResultLib.StoreErrorImage( )

Calls DBLibraryget.DBValues . . . 8 to retrieve Error Test Cases with image

If present call DatabaseLibrary.InsertErrorTestCaseDet( ) to insert error information into TABLE4

Calls DBLibrary.getResultStatus

Get Condition status from DB

Control returns to ResultFun

Check pass/fail status

### Power Off Exception

OPUS checks if Test Execution control file exists in the folder. This file contains the execution status

If it exists

Call PowerOffExceptionCall( )

Call OPUSMainForm.OPUSMainForm( )

Call OpenConfig( ) to open configuration file.

Call runTestToAddOn( ) to start execution.

Call QTP MainForm. The rest of the steps are the as in Test execution.

### Version Differentiator

### Activity Diagram—Sub Components

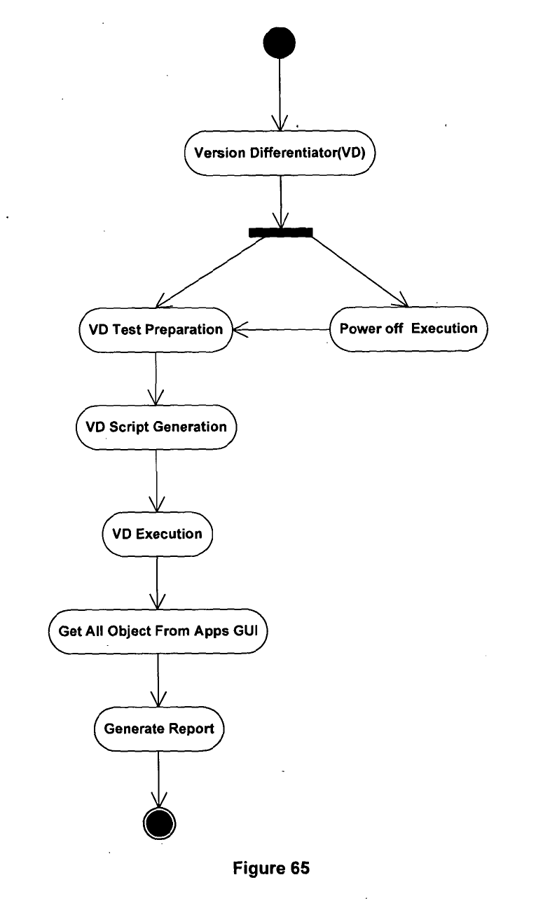

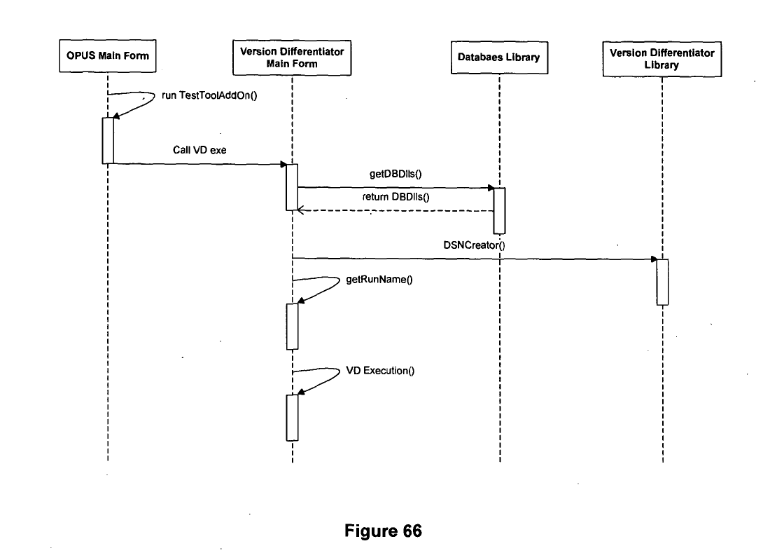

### Refer FIG. 65: Activity Diagram for Version Differentiator.

### Sub Components

### Test Creation

### Refer FIG. 66: Sequence Diagram for Test Creation in Version Differentiator.

### Script Generation for Version Differentiator

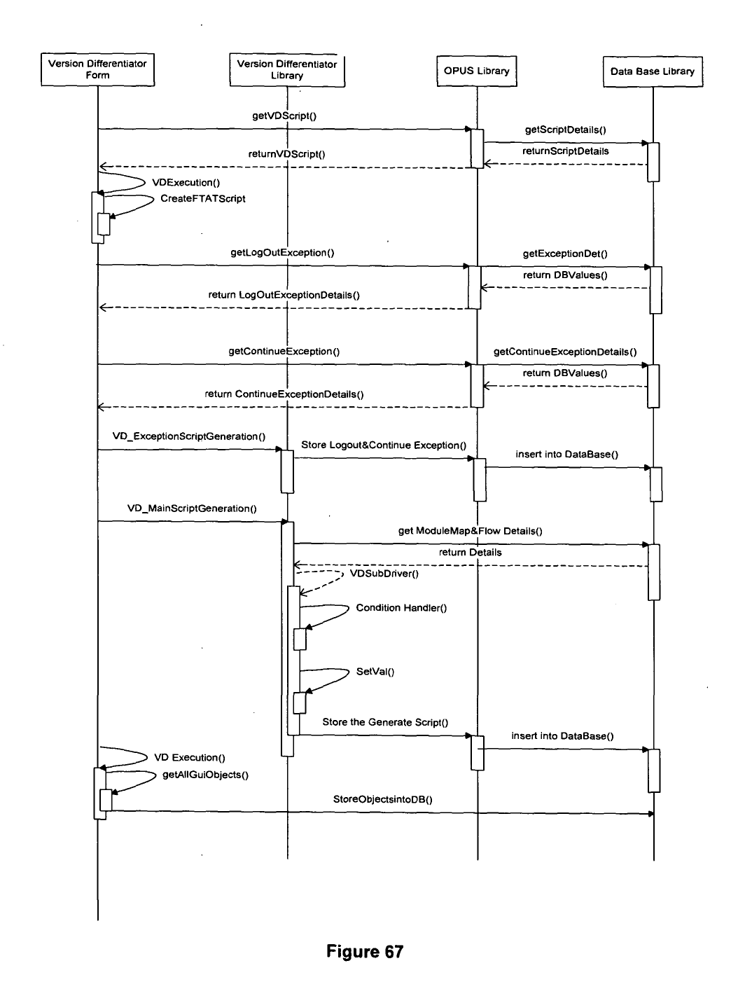

### Refer FIG. 67: Sequence Diagram for Script Generation in Version Differentiator

### Version Differentiator Execution

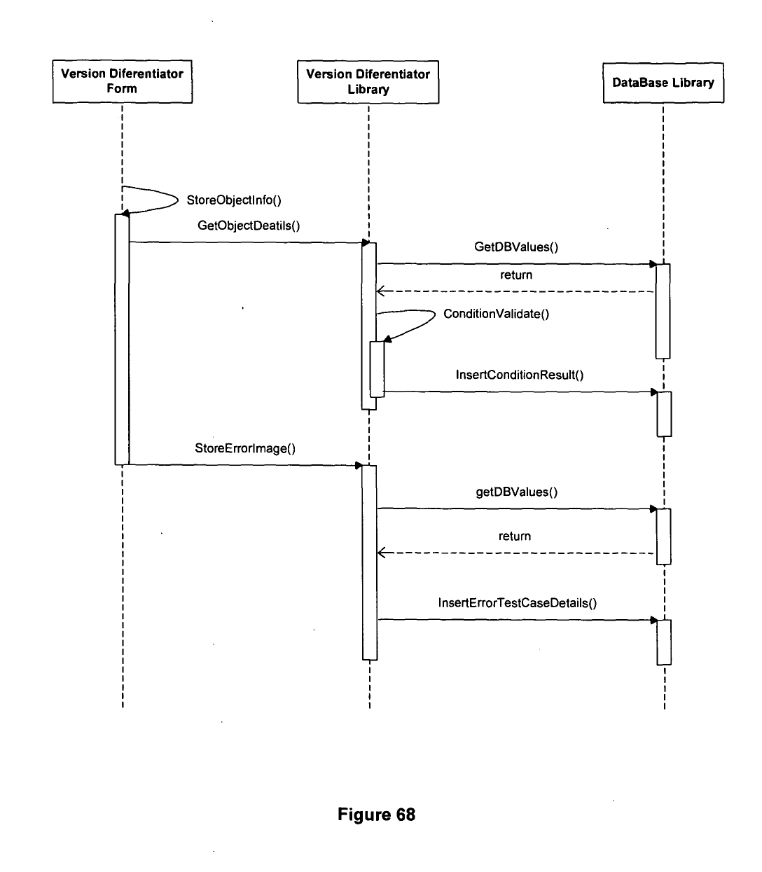

### Refer FIG. 68: Sequence Diagram for Test Execution in Version Differentiator

### Flow Chart

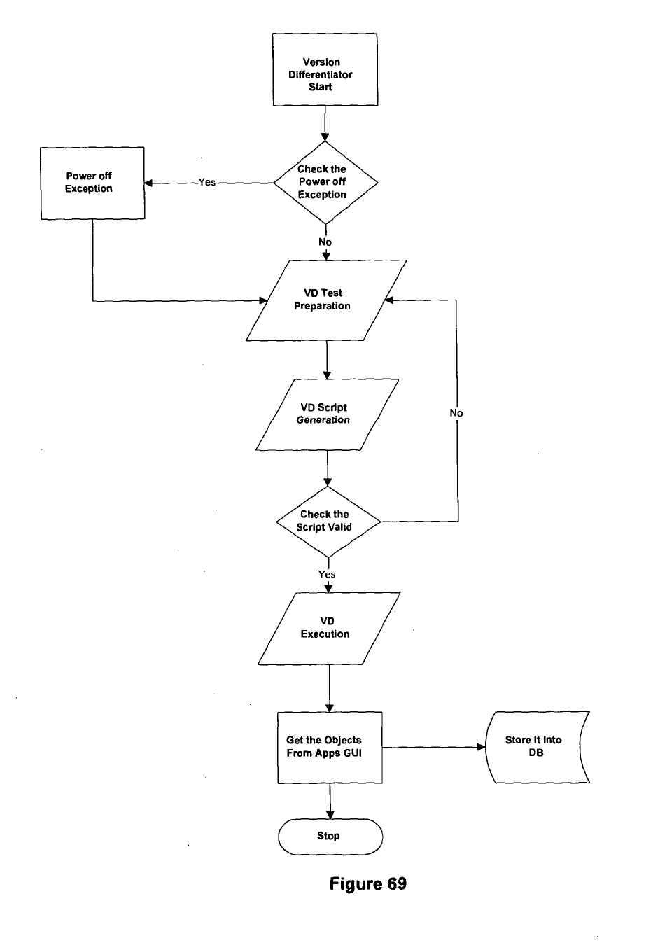

### Refer FIG. 69: Flowchart for Version Differentiator

### Algorithm

### Test Creation

User navigates to OPUSMainForm to initiate Version differentiator

User Select the Analyze Tab and

User Enter the Version Name and Click the run button

call runTestToolAddon( ) which calls OPUS_VD.Exe

OPUS_VDExe VDMainForm opens up

THis calls DatabaseLibrary.GetDBDIIs

This returns all the objects for the corresponding Database

From VD Main form call DSNCreate

THis creates a DSN for the Database

VDMain form calls VD Execution

### Script Generation for Version Differentiator

Execution form calls OPUSLibrary.getExecutedScripts( )

This object calls DatabaseLibrary.getScriptDetails( )

The object retrieves the all test cases to be run—selected test cases in Test Packs

Control return to Execution form

Execution form Calls VDcodeCreate( ). This method creates the requisite folder structure and the default files

VDcodeCreate( ) calls createVDScript( ) which re creates VB script for VD. The scripts are generated as follows

Take the first Test case in the Test Configuration

Identify the objects associated with the Test case, in the Flow data repository

Identify Data conditions associated with the Test Case in the Flow Data repository

Identify action conditions associated with the object identified in the steps above.

Re construct the VD script by composing objects data and action

Add VB Script Library for the VD to the generated script

Call OPUSLIbray.getLogoutExceptionDetails( ) to return information regarding unplanned log out

Return control to execution Form

Call OPUSLibrary.getContinueException( ) to get details regarding exceptions encountered during previous run

Return control to Execution Form

Call VDLibrary.VD_ExceptionScriptGeneration( ) to generate Generates exception related script

Call OPUSLibrary.continueLogoutExceptionScript( )

This method calls DatabaseLibrary.insert into Database( ) to insert Logout and continue exception data to the Database.

From ExecutionForm calls VDLibrary.VD_MainScriptGen( )

This method in turn calls DBLibrary.getModuleMap&FlowDet( )

This method returns Map and flow details

Control returns to VD Library

Calls VDSubDriver( )

This method divides script into normal script and condition script and also added the get objects properties script into normal script

If condition script call Condition handler to generate this generates condition script

Else call VDSubDriver( )

End If

Calls Setval( ) to generate normal VD Script

Call OPUSLibrary.storeTheGeneratedScript to invoke DatabaseLibrary to save generated VD script in TABLE5

Return control to Execution Main Form

### Version Differentiator Execution

Control is with ExecutionForm

Calls result( )

Result( ) method calls Resultlibrary.resultGeneration( )

Resultlibrary.resultGeneration( ) calls getDBvalues( ) to obtain results from TABLE5 (temporary storage)

Return control to ResultLibrary

Calls conditionvalidate( )

This method retrieves data for the conditions and matches with data generated during run to determine pass/fail status of the condition

Control is returned to ResultLibrary

Calls DBLibrary.insert results to TABLE4

Control returns to ExecutionForm

Calls ResultLib.StoreErrorImage( )

Calls DBLibraryget.DBValues . . . 8 to retrieve Error Test Cases with image

If present call DatabaseLibrary.InsertErrorTestCaseDet( ) to insert error information into TABLE4

Calls DBLibrary.getResultStatus

Get Condition status from DB

Control returns to ResultFun

Check pass/fail status

### GLOSSARY

| | |
|---|---|
| ASCII | American Standard Code for Information Interchange |
| AUT | Application under test |
| BM | Business module |
| BO | Business object |
| BOI | Business object identifier |
| BP | Business process |
| BPI | Business process identifier |
| CTP | Common Test Platform |
| DB | Database |
| DSA | Data security algorithm |
| DVC | DVC Data verification control |
| FTAT | Functional test automation tool |
| GDC | Generic data container |
| HP | Hewlett-Packard |
| HP QC | Hewlett-Packard Quality Center |
| IBM | International Business Machines |
| ISG | Intelligent script generator |
| MTC | Multiple test configuration |
| NCD | Non-application centric data |
| OAT | OPUS Audit trail |
| QMS | Quality management system |
| QTP | QuickTest Professional |
| SQL | Structured query language |
| TTE | Test tool engine |
| TPI | Test progress indicator |
| EEH | Extreme exception handler |
| DKO | Dynamic key optimizer |
| DCE | Data change engine |
| HLT | High Level Test Case |
| LLT | Low Level Test Case |

### APPENDICES

### Appendix A

### Platforms Currently Supported by OPUS

These are correct as at November 2011.
Windows applications
Middleware
Client—Server applications
AS/400 or System i
Web applications
Java
NET Framework

### Appendix B

### Compatible Quality Management Systems

Correct as at November 2011
HP QC—Hewlett-Packard Quality Center
CTP—Net Magnus Common Test Platform

### Appendix C

### Example and Definitions

Example of how the Business Process relates to a Business Object:

1 AUT: Many Business Processes (BP)

1 BP: Many Business Modules (BM)

1 BM: Many Classes

1 Class: Many Business Objects (BO)

In an Internet banking application, classes could be a button and a text box. For the text box class, the BO could be the login text box and the password text box.

### DEFINITIONS

Flow—A Flow is a unique business process within the application under test (AUT).

All unique business processes within the AUT are automatically generated by OPUS without the need for human intervention

Module—A business process may comprise of one or more business components or modules. All unique modules are identified and associated with their corresponding business processes by OPUS in a fully automated manner.

Condition—A test condition is the most granular element of a test. Test Condition definition, build and verification increases the testing efficiency of the automated suite.

### Appendix D

### Output File Formats

These are correct as at November 2011.
xls
pdf
csv
html
txt

### Appendix E

### Encryption

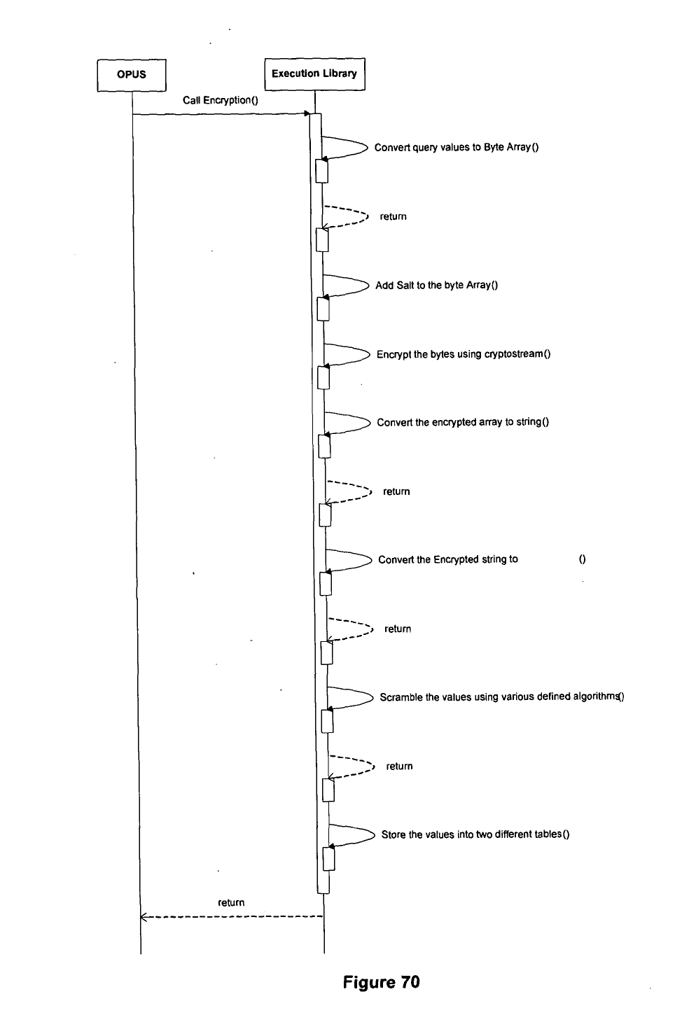

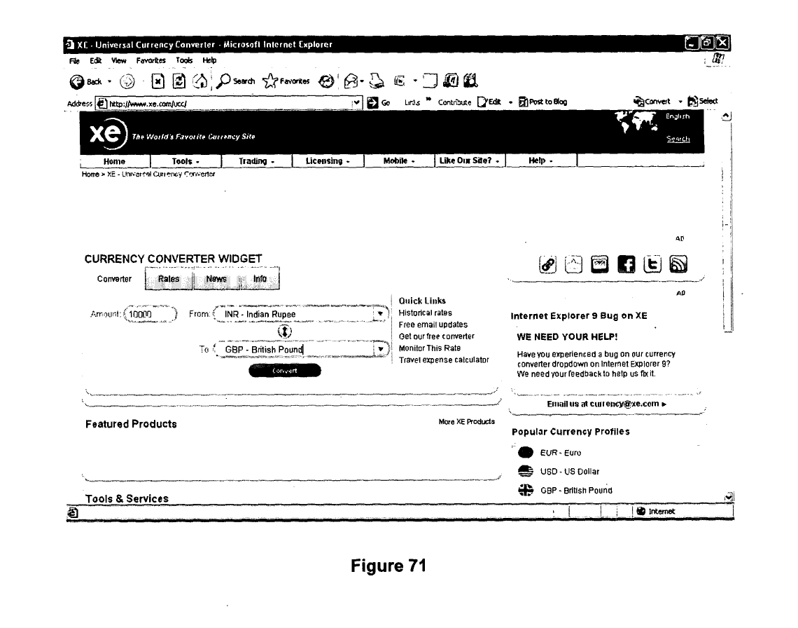

### Refer FIG. 70: Sequence Diagram for Encryption

### Steps:

Convert Query values to Byte Array

Add ‘Salt’ to the Byte Array

Encrypt the Bytes with Cryptogram

Converted the encrypted Array to String

Converted the encrypted string to hexadecimal

Scramble the values using various defined algorithms

Store the values into different tables

### Appendix F

### Left Blank

### Appendix G

### Database Schema

### Database Name: Test Pack Name

### Name of the Table: TABLE 1

Module map is a repository that holds information regarding the Application windows and related Window objects. Each object is assigned a unique identifier. Object identifier consists of two parts separated by hyphen. The first part is the Window identifier which is a unique serial number. The other part is a unique serial number to represent the object.

A window and associated objects will have only single reference in the Module map, across the Test cases. Window and object information is not repeated even if the same window may appear in another test case. However if there are object windows newly referred in the Test case, OPUS shall append the information on these objects to the Module Map.

Flow data represents the QTP scripts. OPUS processes QTP scripts to separate information on Objects data and conditions and store them separately in Table1 and Table3. Data and conditions are concatenated with a delimiter and stored in the same table.

Steps consisting of objects in sequence are assigned a unique Test Id. A different object ID is assigned to the steps should any of the object reappear in the sequence

### Module Map & Flow Data

| # | Column name | Type | Size | P.Key |
|---|---|---|---|---|
| 1 | Column1 | Text | Max. Size | |
| 2 | Column2 | Text | Max. Size | |
| 3 | Column3 | Text | Max. Size | |
| 4 | Column4 | Text | Max. Size | |
| 5 | Column5 | VARCHAR(3500) | Max. Size | Yes |
| 6 | Column6 | Text | Max. Size | |

### Database Name: Test Pack Name

### Name of the Table: TABLE 2

### Application & Test Pack Details

| # | Column name | Type | Size |
|---|---|---|---|
| 1 | Column1 | Text | Max. |
| | | | Size |
| 2 | Column2 | Text | Max. |
| | | | Size |
| 3 | Column3 | Text | Max. |
| | | | Size |
| 4 | Column4 | Text | Max. |
| | | | Size |
| 5 | Column5 | Text | Max. |
| | | | Size |
| 6 | Column6 | Text | Max. |
| | | | Size |

### Database Name: Test Pack Name

### Name of the Table: TABLE 3

### Module Map & Flow Data

| # | Column name | Type | Size | P.Key |
|---|---|---|---|---|
| 1 | Column1 | Text | Max. Size | |
| 2 | Column2 | Text | Max. Size | |
| 3 | Column3 | Text | Max. Size | |
| 4 | Column4 | Text | Max. Size | |
| 5 | Column5 | Varchar(3500) | Max. Size | Yes |
| 6 | Column6 | Text | Max. Size | |

### Database Name: Test Pack Name

### Name of the Table: TABLE 4

### Result

| # | Column name | Type | Size |
|---|---|---|---|
| 1 | Column1 | Text | Max. |
| | | | Size |
| 2 | Column2 | Text | Max. |
| | | | Size |
| 3 | Column3 | Text | Max. |
| | | | Size |
| 4 | Column4 | Text | Max. |
| | | | Size |
| 5 | Column5 | Text | Max. |
| | | | Size |
| 6 | Column6 | Text | Max. |
| | | | Size |

### Database Name: Test Pack Name

### Name of the Table: TABLE 5

### Temporary Table

| # | Column name | Type | Size |
|---|---|---|---|
| 1 | Column1 | Text | Max. |
| | | | Size |
| 2 | Column2 | Text | Max. |
| | | | Size |
| 3 | Column3 | Text | Max. |
| | | | Size |
| 4 | Column4 | Text | Max. |
| | | | Size |
| 5 | Column5 | Text | Max. |
| | | | Size |
| 6 | Column6 | Text | Max. |
| | | | Size |

### Database Name: NMDB

### Name of the Table: RTABLE 1

### Data: Configuration Details

### Temporary Table

| # | Column name | Type | Size |
|---|---|---|---|
| 1 | Column1 | Text | Max. Size |
| 2 | Column2 | Text | Max. Size |
| 3 | Column3 | Text | Max. Size |
| 4 | Column4 | Text | Max. Size |
| 5 | Column5 | Text | Max. Size |
| 6 | Column6 | Text | Max Size |

### Database Name: NMDB

### Name of the Table: RTABLE 2

### Audit Changes Details

### Temporary Table

| # | Column name | Type | Size |
|---|---|---|---|
| 1 | Column1 | Text | Max. Size |
| 2 | Column2 | Text | Max. Size |
| 3 | Column3 | Text | Max. Size |
| 4 | Column4 | Text | Max. Size |
| 5 | Column5 | Text | Max. Size |
| 6 | Column6 | Text | Max Size |

### Database Name: Test Pack Name

### Name of the Table: TABLE 6

### Version Differentiator Table

| # | Column name | Type | Size |
|---|---|---|---|
| 1 | Column1 | Text | Max. Size |
| 2 | Column2 | Text | Max. Size |
| 3 | Column3 | Text | Max. Size |
| 4 | Column4 | Text | Max. Size |
| 5 | Column5 | Text | Max. Size |
| 6 | Column6 | Text | Max. Size |

### Appendix H

### Comparison Between ‘Functional Test Automation’ and ‘Opus Enabled Functional Test Automation’

A foreign exchange portal (XE.com) has been selected to illustrate functional test automation using an FTAT alone. The same is also demonstrated using Opus along with an FTAT.

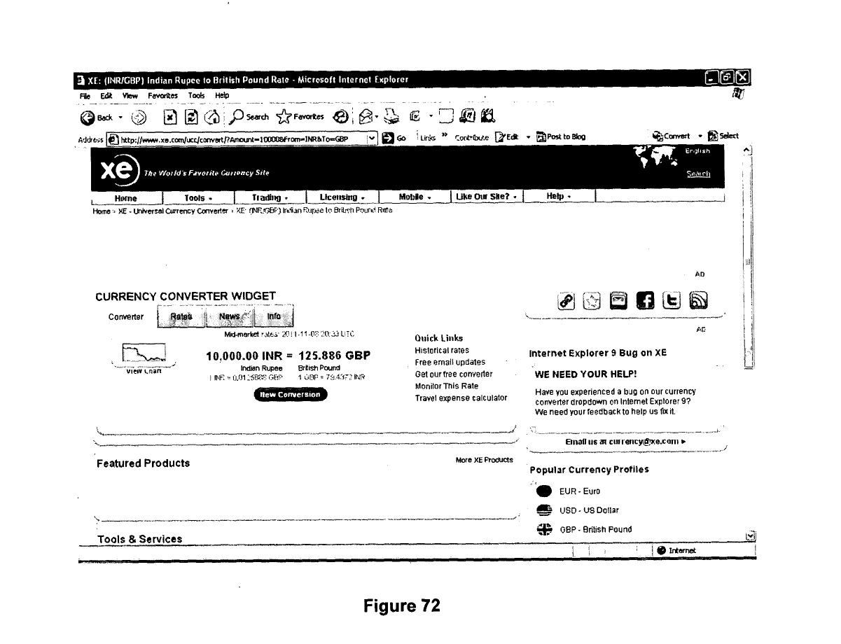

### Refer FIG. 71 and FIG. 72.

### Test Requirement

The scope of the requirement is limited to retrieval of values from the portal and it's storage in DB tables.

Connect to web site. Validate connection

Set ‘Amount’ to 10000

Choose INR as the ‘From’ currency

Choose GBP as the ‘To’ currency

Capture the displayed value and store in a data store for reference downstream

### Automation Solution Using HP Quick Test Pro (QTP) a Functional Test Automation Tool (FTAT).

QTP is a record and playback test automation tool primarily used to perform functional and regression testing of GUI applications. QTP automates testing by generating scripts which represent user actions on the application under test. The recorded scripts are executed or played back during regression test cycles. Users also add data verification points to the scripts which are validated during script playback.

QTP fairly supports testing of basic application functionality in the record and playback mode. However, for advanced testing, the user needs to modify the played back script and introduce programmatic constructs. This requires technical users with programming knowledge who must also validate the scripts he or she writes there by impacting project time line and effort.

To implement the above test requirement, the technical user captures the values from the screen using QTP native functions. However to save the values in the user defined DB tables, the user should modify the recorded scripts by adding logical routines in VB script as illustrated below. As is evident, user must be proficient in programming logic and the programming language which is VB script. Also the user must spend time and effort to test the script for possible bugs. This takes away considerable time off the test project schedule which in turn impacts the project deadline.

The sample script for automating the above requirement is given below:

SystemUtil.Run “C:\Program Files\Internet
Explorer\IEXPLORE.EXE”, “”, “C:\Documents and Settings\Netmagnus”, “open”
Browser(“Browser”).Page(“Page”).Sync
Browser(“Browser”).Navigate “http:/www.xe.com/”
Browser(“Browser”)Page(“XE - The World’s Favorite).Link(“More currencies”).Click
Browser(“Browser”).Page(“XE - Universal Currency”).WebEdit(“Amount”).Set
“10000”
Browser(“Browser”)Page(“XE - Universal Currency”).WebEdit(“WebEdit”).Set “INR -
Indian Rupee”
Browser(“Browser”).Page(“XE - Universal Currency”).WebEdit(“WebEdit_{—}2”).Set
“GBP - British Pound”
‘Get the values from the object at run-time
inputAmount = Browser(“Browser”).Page(“XE - Universal
Currency”).WebEdit(“Amount”).GetROProperty(“value”)
currencyFrom = Browser(“Browser”).Page(“XE - Universal
Currency”).WebEdit(“WebEdit”).GetROProperty(“value”)
currencyTo = Browser(“Browser”).Page(“XE - Universal
Currency”).WebEdit(“WebEdit_{—}2”).GetROProperty(“value”)
Browser(Browser”).Page(“XE - Universal Currency”).WebButton(Convert”).Click
convertedAmount = Browser(“Browser”).Page(“XE: (INR/GBP) Indian
Rupee”).WebTable(“Mid-market”).GetCellData(3,3)
Call insertvalues(inputAmount,currencyFrom,currencyTo,convertedAmount)
Browser(“Browser”).Page(“XE:(INR/GBP) Indian Rupee”).WebTable(“Mid-
market”).Check CheckPoint(“Mid-market”)
Browser(“Browser”).Page(“XE:(INR/GBP) Indian Rupee”).Sync
Browser(“Browser”).Close
‘Function Name : insertvalues
‘Parameters : inputAmount,currencyFrom,currencyTo,outputAmount
‘Purpose : To store the values into database
Function insertvalues(inputAmount,currencyFrom,currencyTo,outputAmout)

Dim dbCon

Set dbCon = CreateObject(“ADODB.Connection”)
dbcon.Open(“DSN=Test;UID=NetMagnus;PWD=netmag;APP=QuickTest

Professional;WSID=NMSIDEMO03;DATABASE=TestDB;”)

query = “insert into conversion_{—}details values(“& inputAmount&”,‘“&

currencyFrom&”’,‘“& currencyTo&”’,‘“& outputAmout&”’);”

dbCon.Execute(query)
dbcon.Close

End Function

The script marked in bold is hand coded by the user. The script marked in italics is recorded on the FTAT.

In Sum What the Script does is the Following

Get the object property values at run-time

Connect to DB

Insert the captured values in the DB tables

However this Requires the Tester to have Programming Skills

### Automation Solution Using OPUS Enabler

The same operation using Opus:

The slightly complex Test requirement explained above is automated using OPUS without need of any programmatic skills.

OPUS provides pre defined data functions on GUI which allows the user to implement the test requirement without modification to recorded scripts. This eliminates the need for a technical user who is proficient in programming, logic and DB operations. This unique feature of OPUS saves considerable time and effort which otherwise would have been spent on programming, debugging and defect fixing of the modified script. Naturally, OPUS boosts the productivity.

When the user uses OPUS he needs to perform only simple basic recording using the automation tool. The script is given below:

SystemUtil.Run “C:\Program Files\Internet
Explorer\IEXPLORE.EXE”,“”,“C:\Documents and Settings\Netmagnus”,“open”
Browser(“Browser”).Page(“Page”).Sync
Browser(“Browser”).Navigate “http://www.xe.com/”
Browser(“Browser”).Page(“XE - The World's Favorite”).Link(“More currencies”).Click
Browser(“Browser”).Page(“XE - Universal Currency”).WebEdit(“Amount”).Set
“10000”
Browser(“Browser”).Page(“XE - Universal Currency”).WebEdit(“WebEdit”).Set “INR -
Indian Rupee”
Browser(“Browser”).Page(“XE - Universal Currency”).WebEdit(“WebEdit_2”).Set
“GBP - British Pound”
Browser(“Browser”).Page(“XE - Universal Currency”).WebButton(“Convert”).Click
Browser(“Browser”).Page(“XE: (INR/GBP) Indian Rupee”).WebTable(“Mid-
market”).Check CheckPoint(“Mid-market”)
Browser(“Browser”).Page(“XE: (INR/GBP) Indian Rupee”).Sync
Browser(“Browser”).Close

You can see that there are no programmatic constructs here.

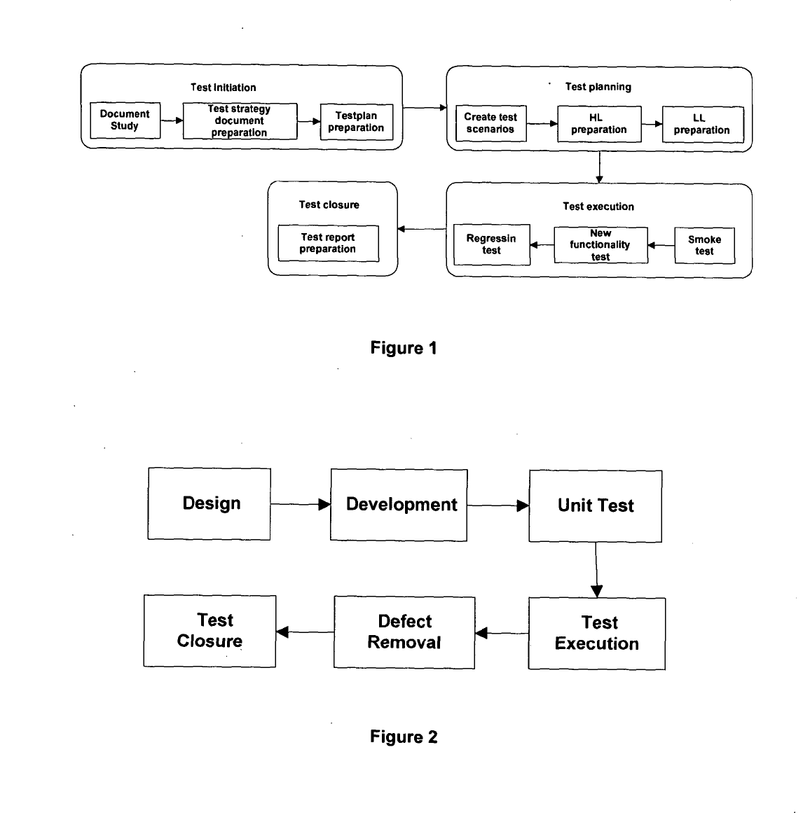

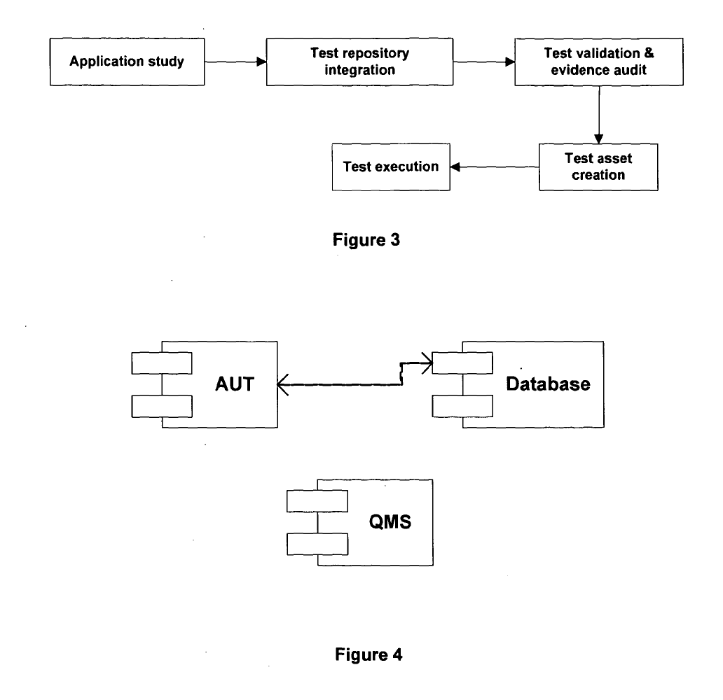

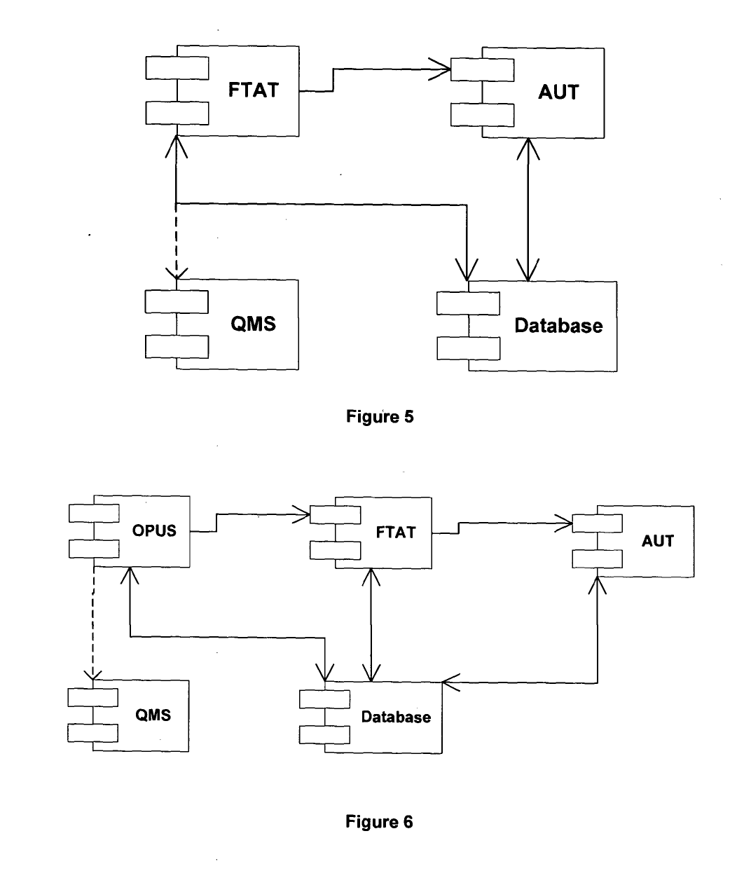

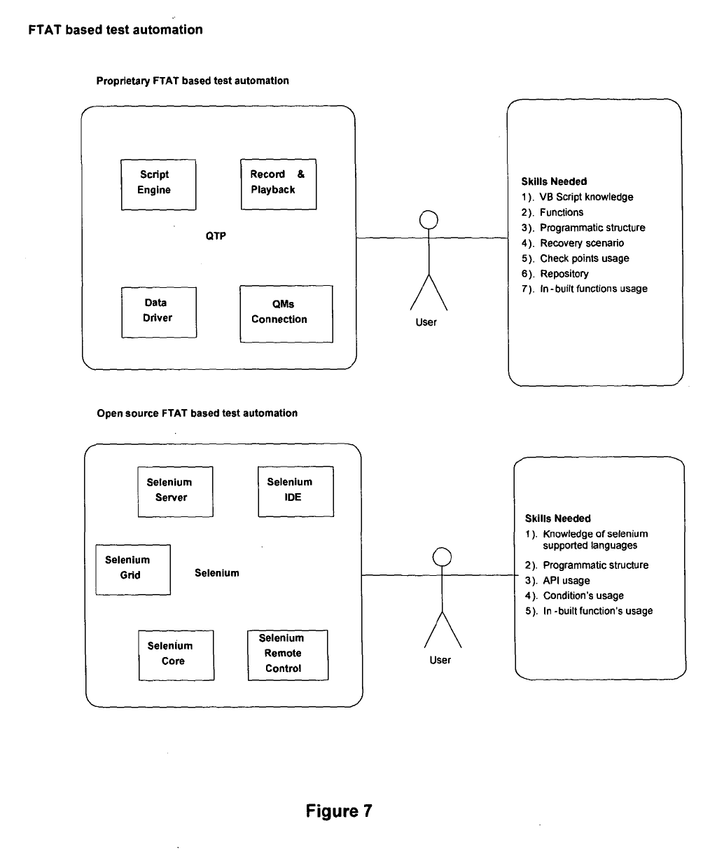

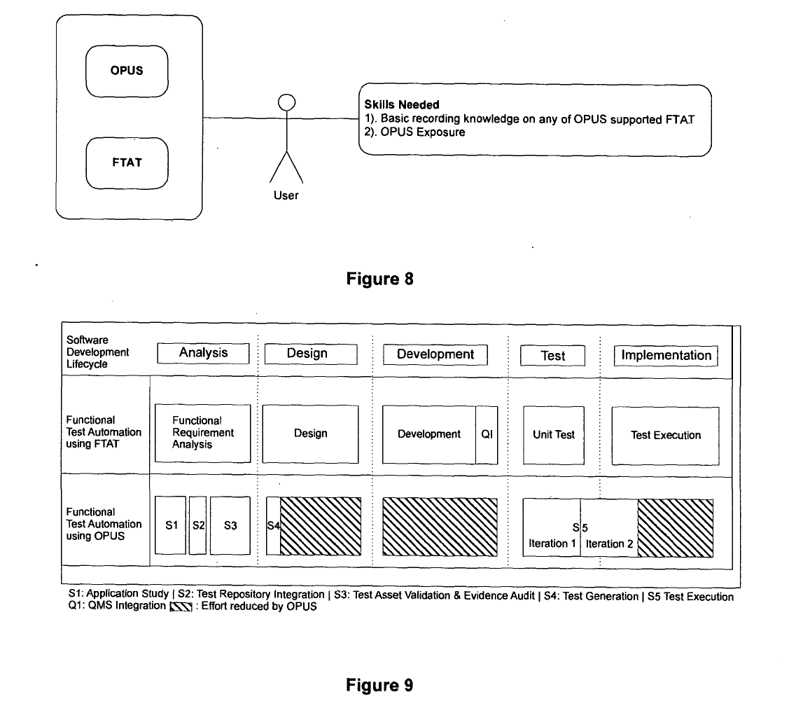

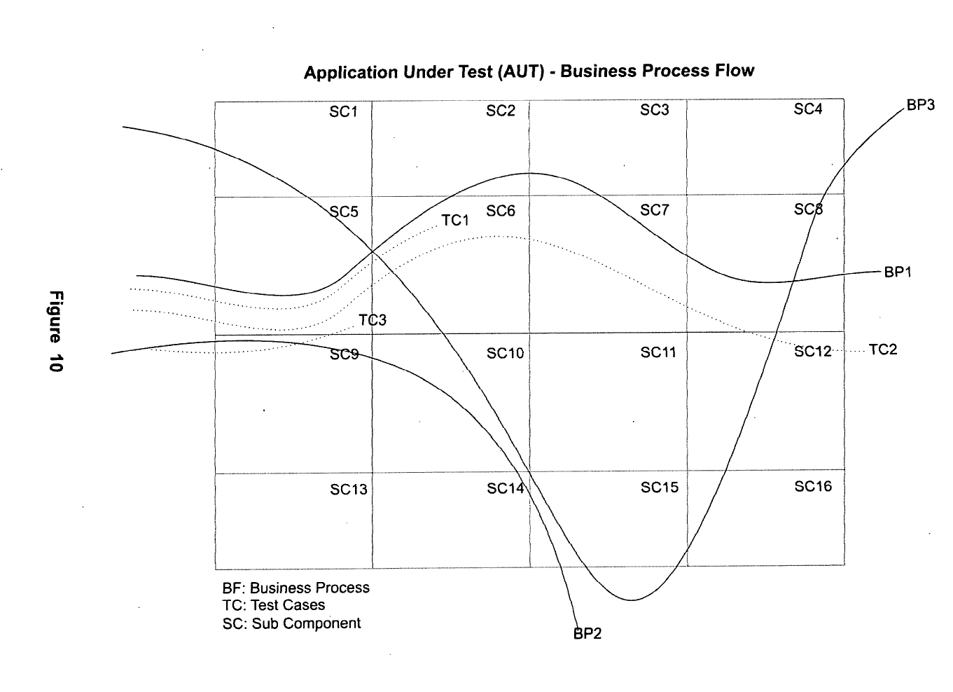

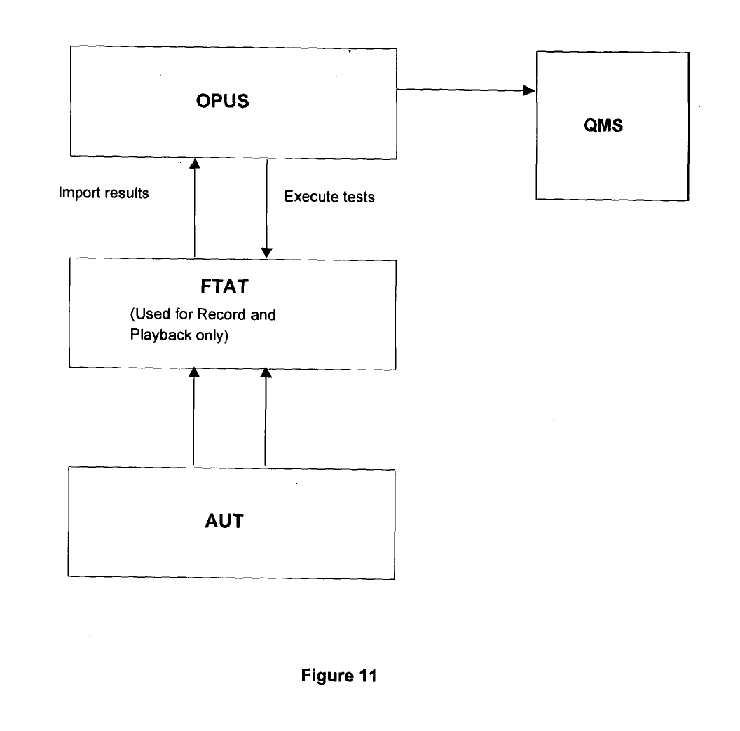

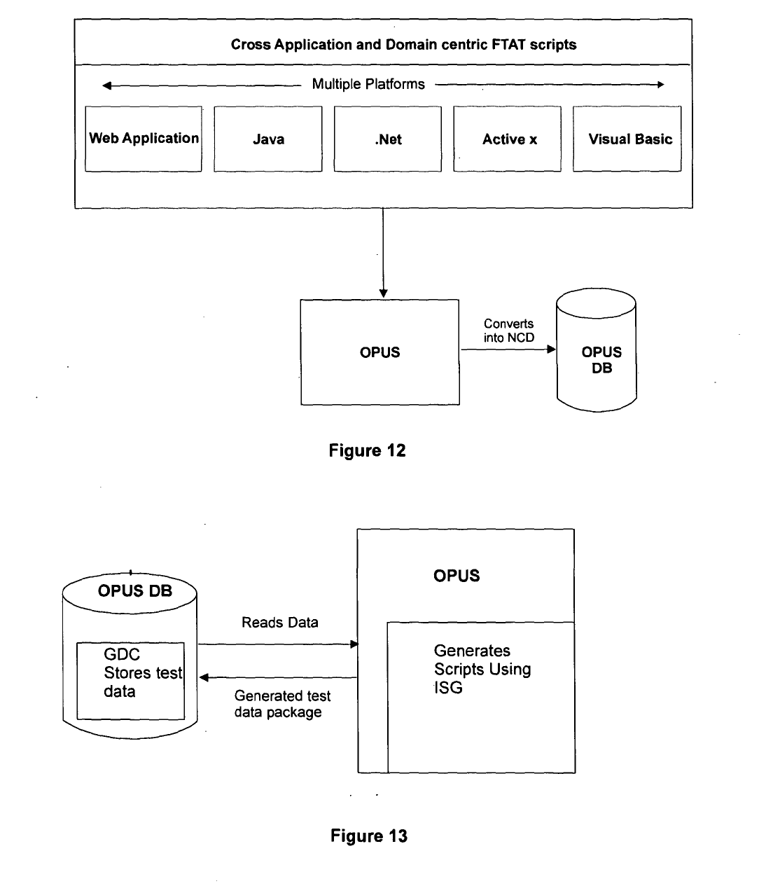

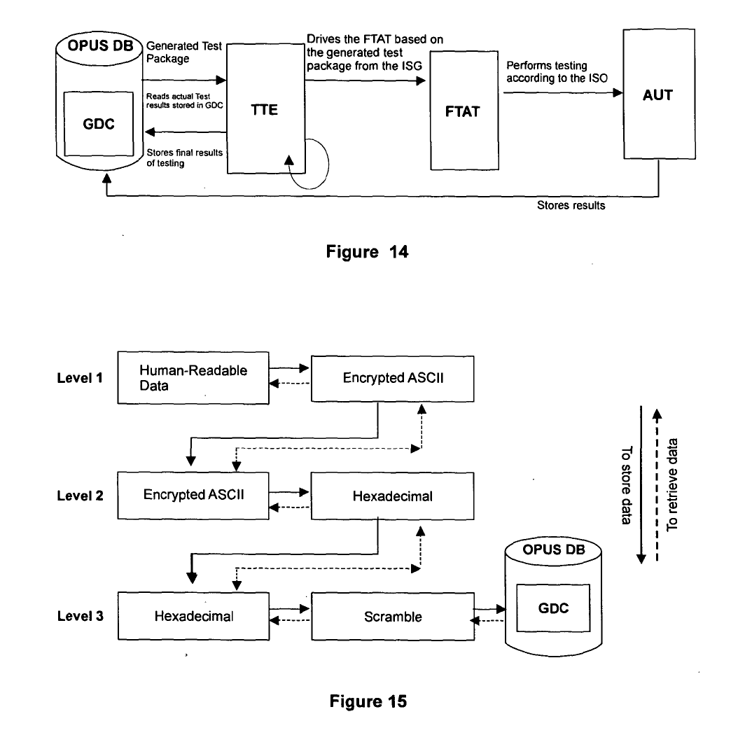

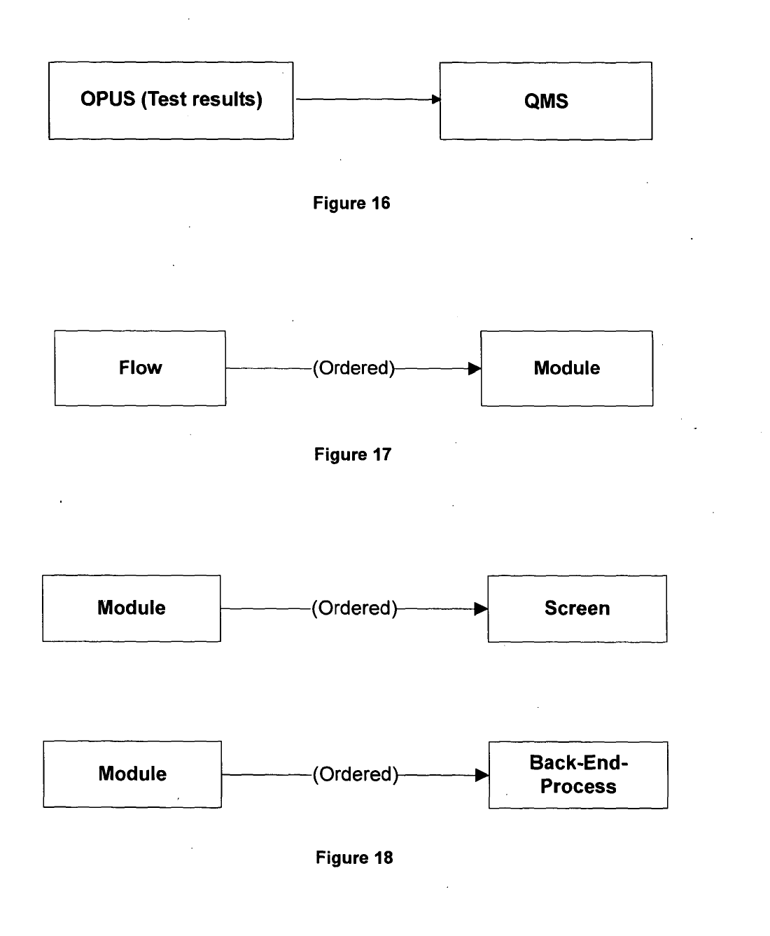

The script above is processed by OPUS and converted to its native format which again is very user friendly and allows the user to modify it without producing any undesirable bugs. Refer FIG. 1.

To explain the process:

Given below are the images of OPUS screens with steps, which facilitate the implementation of the above requirement without any programming.

### Step 1

OPUS converts the QTP scripts to OPUS formats

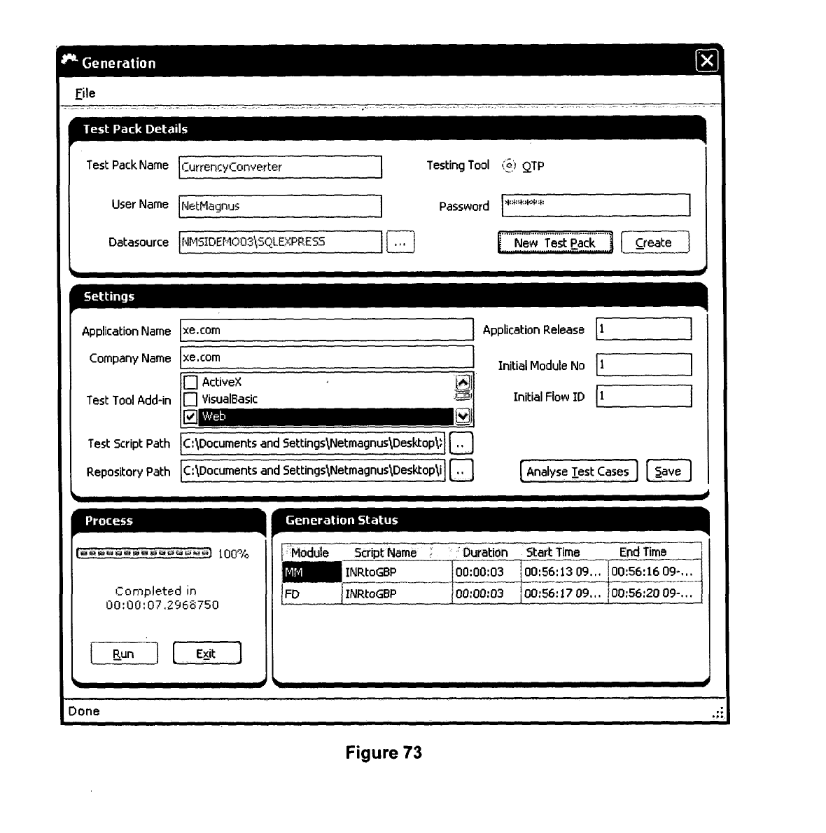

Refer FIG. 73: Generation. This operation removes the requirement of the tester's capability to program/code

### Step 2

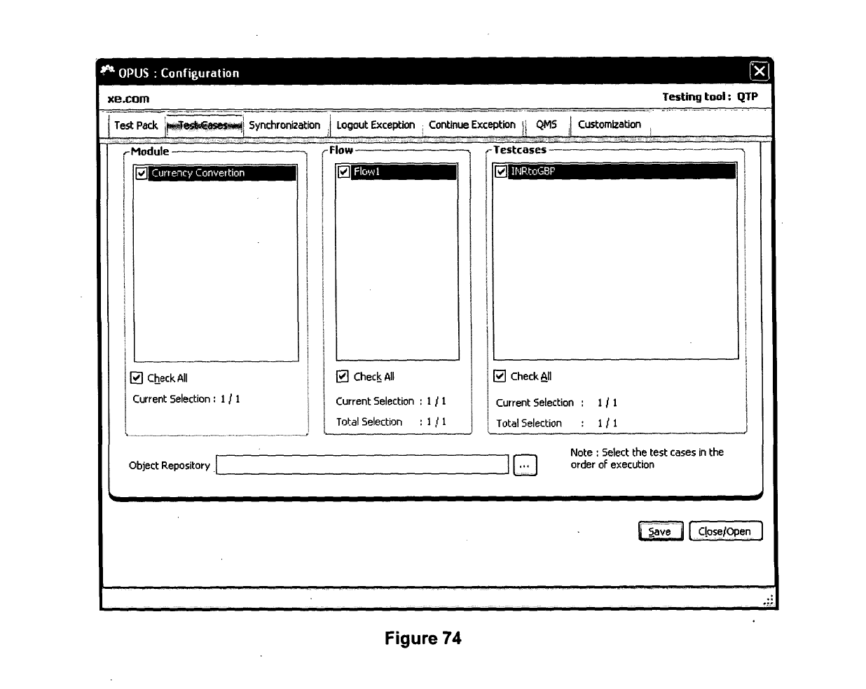

Group Test cases. Refer FIG. 74. Configuration

### Step 3

### Data Modification

This is the screen on which the tester can view the original QTP script in OPUS format which is easy to modify without causing undesirable bugs.

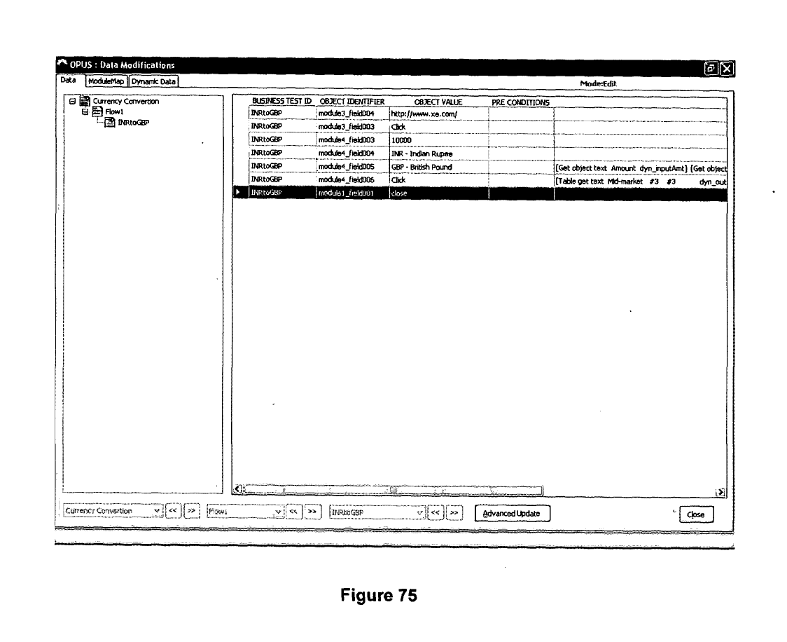

Refer FIG. 75: Data Modification

This screen presents the original script in the OPUS native format.

### Step 4

This step uses OPUS built in functions to capture run time values from the web page explained above

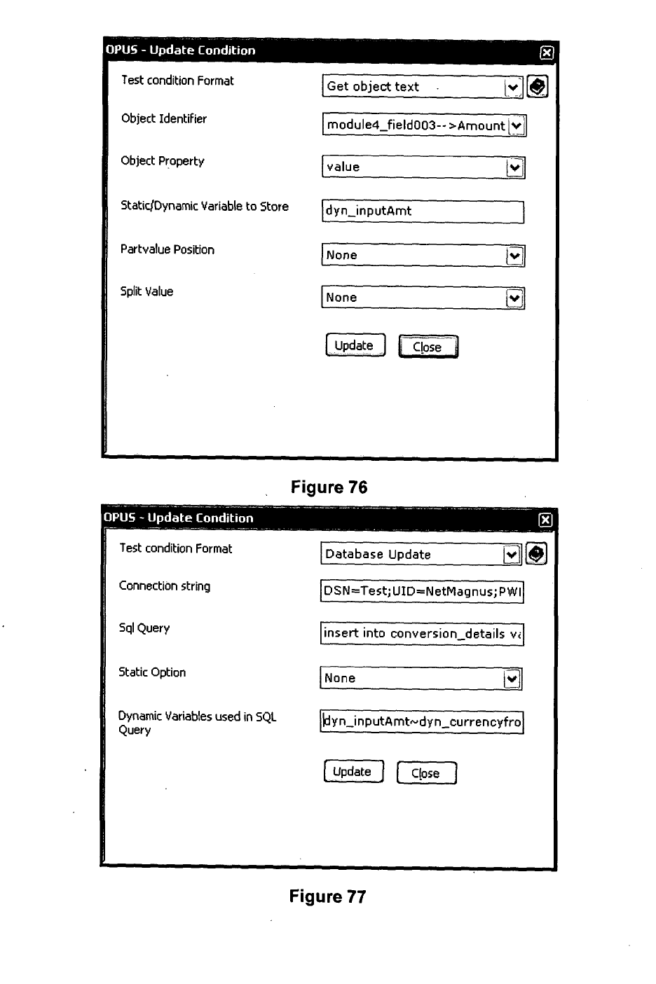

Refer FIG. 76: Update Condition

### Step 5

In this step the captured values are inserted into the DB tables.

Refer FIG. 77: Update Condition

### Step 6

Viewing results

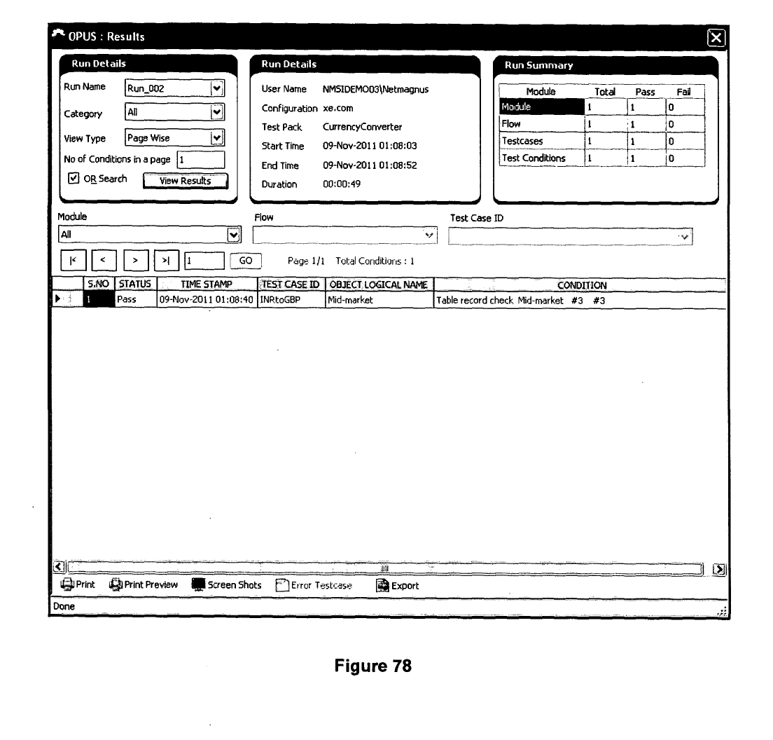

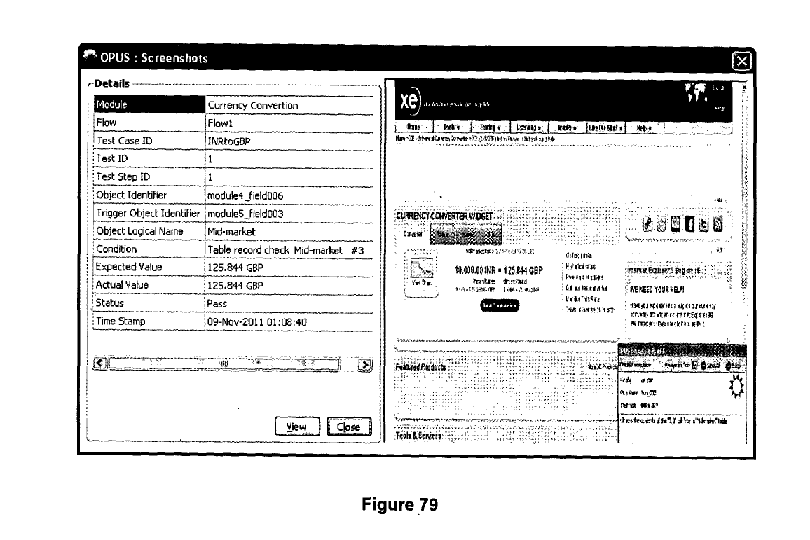

Refer FIG. 78: Viewing Results

### Step 7

Refer FIG. 77. Condition details

1. A method of automatically testing different software applications for defects, comprising the steps of a test automation enabler:
(a) converting recorded test scripts into a generic format that is not application-centric; and
(b) storing the resultant non-application centric data in generic data containers.

2. The method of claim 1 in which the software applications are of different types and/or run on different platforms and/or different domains.

3. The method of claim 1 in which the test automation enabler configures the generic data for test execution and runs the test configuration using a chosen FTAT (functional test automation tool).

4. The method of claim 1 in which the test automation enabler uses generic data containers (GDC) to store its data; these are a finite set of tables with no specific field names, but with uniform field definitions where the columns are used generically to store the data in a random placement.

5. The method of claim 1 in which the test automation enabler includes an Intelligent Script Generator (ISG) that uses the data in the GDC and converts it into scripts which are recognised and executed by the FTAT.

6. The method of claim 1 in which the test automation enabler includes a Test Tool Engine (TTE) that takes the output from the ISG to drive the FTAT to perform automated testing.

7. The method of claim 1 in which the test automation enabler includes Data Security Algorithms (DSA) that take human-readable data as its input, before encrypting, scrambling and storing in the GDC.

8. The method of claim 1 in which the test automation enabler includes an Advanced Data Change Engine, that enables the data used for testing to be changed throughout the test pack, without modifying the scripts or reimporting/reprocessing them.

9. The method of claim 1 in which the test automation enabler includes Dynamic Keys that can be used to avoid redundant test steps, fetch a value generated by the application under test (AUT) during the execution process to be used at a later stage, and minimise the impact due to changes in data.

10. The method of claim 1 in which the test automation enabler includes an Audit Trail (OAT) feature that tracks changes made to test data that is stored in the GDC.

11. The method of claim 1 in which the test automation enabler includes a Multiple Test Configuration (MTC) that allows test cases to be grouped and configured based on user preference and the need, purpose, or requirement for testing the AUT.

12. The method of claim 1 in which the test automation enabler includes an Extreme Exception Handler (EEH) that uses several exception handling strategies and can handle known and unknown scenarios, and can also resume the automated testing from where it had been stopped after unexpected power shut down.

13. The method of claim 1 in which the test automation enabler has the ability to upload the test execution results, with multiple types of evidence, into the quality management system at the most granular level of the test case (either test step or test condition).

14. The method of claim 1 in which the test automation enabler includes a Test Scheduler that has the option to schedule, stop and re-start the test execution process in multiple machines at a specified date and time.

15. The method of claim 1 in which the test automation enabler has the intelligence to identify the unique business processes in the application and group the test cases accordingly, allocating a unique Business Process Identifier to each process.

16. The method of claim 1 in which the test automation enabler identifies the unique business objects in the application, and automatically generates a unique identifier which can be called from anywhere in the application.

17. The method of claim 1 in which the test automation enabler includes a Test Progress Indicator that shows the complete status of the test cases and a description of the current execution process.

18. The method of claim 1 in which the test automation enabler includes a Data Verification Control (DVC) that has the ability to verify the business object properties in the application, and also validate the back-end process.

19. The method of claim 18 in which The DVC can access multiple applications, across multiple platforms and verify one or more test condition relating to a single test step.

20. The method of claim 1 in which the test automation enabler includes a Sequence Changer that gives the user the ability to change the sequence in which test cases are navigated and the sequence in which test conditions need to be validated, without having the need to generate new test scripts which are dependent on the FTAT.

21. The method of claim 1 in which the test automation enabler includes a Version Differentiator that analyses new versions of applications under test and locates changes in the version's user interface, in order to assist in gauging the impact of changes and help better manage existing regression suites, and testing of the new version.

22. The method of claim 1 in which the test automation enabler allows data to be modified by simple text editing on a Graphical User Interface (GUI), in which the values recorded for input fields, objects, or class names can easily be changed.

23. The method of claim 22 in which pre-defined data functions are provided on the GUI which allow the user to implement the test requirement without modification to recorded scripts.

24. A computer-implemented test automation enabler system operable to test different software applications for defects, including a test automation enabler (a) converting recorded test scripts into a generic format that is not application-centric and (b) storing the resultant non-application centric data in generic data containers.
